(19) United States
(12) Patent Application Publication
(10) Pub. No.: US 2012/0161556 A1
(43) Pub. Date: Jun. 28, 2012

(54) SUPERCONDUCTING ELECTRIC MOTOR

(75) Inventors: Ryoji MIZUTANI, Nagoya-shi (JP); Yoshimasa Ohashi, Kariya-shi (JP); Nobuo Okumura, Toyota-shi (JP); Kenji Ishida, Nagoya-shi (JP)

(73) Assignee: TOYOTA JIDOSHA KABUSHIKI KAISHA, Toyota-shi (JP)

(21) Appl. No.: 13/323,047

(22) Filed: Dec. 12, 2011

(30) Foreign Application Priority Data
Dec. 28, 2010 (JP) 2010-292502
Dec. 28, 2010 (JP) 2010-292801

(51) Int. Cl. H02K 1/20

(52) U.S. Cl. 310/64

(57) ABSTRACT

A superconducting electric motor includes: a rotor rotatably arranged; a stator arranged in a radial direction of the rotor to face the rotor; and a refrigerator having at least one narrow tube that flows low-temperature refrigerant inside. The stator has a plurality of superconducting coils wound at a radial end portion of a stator core and formed of a superconducting wire material. The at least one narrow tube has a core penetrating portion that is provided to penetrate through the stator core. Alternatively, the refrigerator has a plurality of narrow tubes, and at least part of each narrow tube is provided in the stator core. Connecting portions that are refrigerant supply/drain connecting portions at both ends of each of the plurality of narrow tubes are provided on both axial sides of the stator at opposite sides in a diametrical direction with respect to a rotation central axis of the rotor.

### INCORPORATION BY REFERENCE

The disclosures of Japanese Patent Applications No. 2010-292502 filed on Dec. 28, 2010 and No. 2010-292801 filed on Dec. 28, 2010 including the specification, drawings and abstract are incorporated herein by reference in its entirety.

### BACKGROUND OF THE INVENTION

1. Field of the Invention

The invention relates to a superconducting electric motor and, more particularly, to a superconducting electric motor that includes a refrigerator having at least one narrow tube that flows low-temperature refrigerant inside.

2. Description of Related Art

In an existing art, a superconducting electric motor that includes a refrigerator is suggested. For example, Japanese Patent Application Publication No. 2010-178517 (JP-A-2010-178517) describes a superconducting electric motor apparatus that includes a superconducting electric motor, a cryogenic temperature generator and a casing. The superconducting electric motor includes a rotor and a stator. The rotor includes a rotatable rotary shaft and a plurality of permanent magnets arranged on the outer peripheral portion of the rotary shaft. The stator has three-phase superconducting coils that are wound around the teeth of a stator iron core. The cryogenic temperature generator has a refrigerator that generates cryogenic temperature at its cold head. There is provided a heat conductive portion having a high thermal conductivity. The heat conductive portion connects the cold head to the stator iron core of the stator of the superconducting electric motor so that heat is transferable. A cooling cylindrical portion of the heat conductive portion is cooled into a cryogenic condition, and is brought into thermal contact with the outer peripheral portion of the stator iron core to cool the stator iron core. The casing forms a vacuum insulation chamber that thermally insulates the superconducting coils. Therefore, even when heat is transferred to the superconducting coils or even when refrigeration output from the refrigerator does not catch up, the stator iron core keeps the superconducting coils in a low-temperature condition. In addition, FIG. 3 of JP-A-2010-178517 shows that a heat conductive material having a high thermal conductivity is provided between each of the teeth of the stator iron core and a corresponding one of the superconducting coils, and FIG. 4 of JP-A-2010-178517 shows that a heat conductive material is connected via a connecting portion to the heat conductive portion that surrounds the outer peripheral portion of the stator iron core. With the above configuration, the superconducting coils may possibly be cooled via the teeth cooled by the cryogenic temperature generator.

In addition, International Publication No. WO/2003/001127A1 describes a cool storage refrigerator. The cool storage refrigerator includes pressure control means, an expansion/compression unit and a cool storage unit. The pressure control means have a compressor, a high-pressure selector valve and a low-pressure selector valve. The expansion/compression unit has a room-temperature end portion and a low-temperature end portion. The cool storage unit has a room-temperature end portion and a low-temperature end portion. The cool storage refrigerator transfers heat to a target to be cooled. The cool storage refrigerator couples the low-temperature end portion of the expansion/compression unit to the low-temperature end portion of the cool storage unit, and has a passage of working gas, extending to the target to be cooled. In addition, a pulse tube refrigerator generally serves an important role as cooling means for cooling sensors and semiconductor devices.

As in the case of the superconducting electric motor described in JP-A-2010-178517, in an existing art, cold is transferred by various methods when the superconducting coils are cooled; however, when the solid heat conductive materials are used to cool the superconducting coils, the thermal conductivity of each heat conductive material is finite, so, when heat is transferred through the heat conductive materials having a finite length, there occurs a temperature difference proportional to the amount of heat transferred and, therefore, it is difficult to improve cooling efficiency. For this reason, there is room for improvement in terms of improving the cooing efficiency of the superconducting coils to early cool the superconducting coils to thereby early generate a stable superconducting condition. On the other hand, in order to ensure the cooling performance of a superconducting electric motor irrespective of the load of the superconducting electric motor, it is conceivable to execute control such that the refrigeration output of a refrigerator is increased with the load. However, even in this case, there occurs a delay in response of heat transfer from the output of the refrigerator to the superconducting coils during a high load or in a transitional motor operating state in which the load steeply increases, and the temperature of the superconducting coils increases, so there still exists the possibility that a superconducting condition collapses. For example, in the case where the wheels of a vehicle are driven by a superconducting electric motor, when the superconducting electric motor becomes overloaded or highly loaded because of sudden acceleration, or the like, of the vehicle, the temperature of the superconducting coils may increase, so it is desired to develop means for being able to stably obtain a superconducting condition.

In contrast to this, it is also conceivable that the superconducting coils are cooled in such a manner that a heat conductive material is arranged adjacent to the superconducting coils of a stator core, for example, a heat conductive material for transferring cold generated by a refrigerator is arranged in a slot between adjacent tooth portions of the stator core. However, in this case, the space of each slot in which a heat conductive material is arranged is narrow, so there is room for improvement in terms of improving the flexibility of the installation position of a heat conductive material and improving the mountability of a heat conductive material.

In addition, a superconducting wire material generally used as a superconducting coil has an extremely poor thermal conductivity as compared with a copper wire that constitutes the coils of an electric motor used at normal room temperatures, so the heat-transfer efficiency from a refrigerator to the superconducting coils is poor, and the temperatures of the plurality of superconducting coils may tend to be nonuniform. That is, it is difficult to uniformly cool the plurality of superconducting coils. However, when any one of the plurality of superconducting coils cannot be brought into a superconducting condition, the superconducting coil may steeply generate heat. Therefore, there is room for improvement in terms of effectively preventing burnout due to heat generated by the superconducting coils. For example, in order to avoid a collapse of the superconducting condition of all the superconducting coils, it is conceivable to employ supercooling means for further decreasing the temperature of the plurality of superconducting coils to below a temperature, such as 77 K, to obtain a normal superconducting condition. However, in this case, the power consumption of the refrigerator becomes excessive by that much. Therefore, it is desired to cool the plurality of superconducting coils while reducing the temperature difference, for example, uniformly cool the plurality of superconducting coils.

International Publication No. WO/2003/001127A1 just merely describes a cool storage refrigerator, and does not describe that the refrigerator is used to cool the superconducting coils of the superconducting electric motor.

### SUMMARY OF THE INVENTION

The invention efficiently cools superconducting coils of a superconducting electric motor to a desired cryogenic temperature.

An aspect of the invention relates to a superconducting electric motor. The superconducting electric motor includes: a rotor that is rotatably arranged; a stator that is arranged in a radial direction of the rotor so as to face the rotor; and a refrigerator that has at least one narrow tube that flows low-temperature refrigerant inside, wherein the stator has a stator core and a plurality of superconducting coils that are wound at one radial end portion of the stator core and that are formed of a superconducting wire material, and the at least one narrow tube has a core penetrating portion that is provided so as to penetrate through the stator core.

In addition, in the superconducting electric motor according to the aspect of the invention, the stator core may have an annular back yoke, a plurality of teeth that radially protrude from a radial end portion of the back yoke, and slots, each of which is provided between two of the teeth that are adjacent in a circumferential direction of the stator, the superconducting coils may be respectively wound around the teeth, and the core penetrating portion may be provided so as to penetrate through the back yoke.

In addition, in the superconducting electric motor according to the aspect of the invention, the stator core may have an annular back yoke, a plurality of teeth that radially protrude from a radial end portion of the back yoke, and slots, each of which is provided between two of the teeth that are adjacent in a circumferential direction of the stator, the superconducting coils may be respectively wound around the teeth, and the core penetrating portion may be provided so as to penetrate through one of the teeth.

In addition, in the superconducting electric motor according to the aspect of the invention, the stator core may have an annular back yoke, a plurality of teeth that radially protrude from a radial end portion of the back yoke, and slots, each of which is provided between two of the teeth that are adjacent in a circumferential direction of the stator, the superconducting coils may be respectively wound around the teeth, the refrigerator may have a first narrow tube and a second narrow tube, each of which flows low-temperature refrigerant inside, the first narrow tube may have a first core penetrating portion that is provided so as to penetrate through the back yoke, and the second narrow tube may have a second core penetrating portion that is provided so as to penetrate through one of the teeth.

With the superconducting electric motor according to the aspect of the invention, the at least one narrow tube that is provided for the refrigerator and that flows low-temperature refrigerant inside has the core penetrating portion that is provided so as to penetrate through the stator core. Thus, different from the configuration that a heat conductive material that transfers cold generated by the refrigerator is brought into contact with the opposite end portion of the stator core with respect to the superconducting coils to cool the superconducting coils, the at least one narrow tube that serves as a heat conductive material is brought close to the superconducting coils to efficiently cool the superconducting coils to a desired cryogenic temperature. In addition, the stator core functions as a buffer during heat transfer. By so doing, even during a high load or in a transitional motor operating state, a stable superconducting conduction may be effectively generated. Furthermore, different from the configuration that a heat conductive material is arranged on the stator core adjacent to the superconducting coils to cool the superconducting coils, the installation position flexibility and mountability of the at least one narrow tube that serves as a heat conductive material are improved.

Another aspect of the invention relates to a superconducting electric motor. The superconducting electric motor includes: a rotor that is rotatably arranged; a stator that is arranged in a radial direction of the rotor so as to face the rotor; and a refrigerator that has a plurality of narrow tubes that flow low-temperature refrigerant inside, wherein the stator has a stator core and a plurality of superconducting coils that are respectively wound around multiple radial end portions of the stator core arranged in a circumferential direction of the stator core and that are formed of a superconducting wire material, at least part of each of the plurality of narrow tubes is provided in the stator core, and a one-side connecting portion and an other-side connecting portion that are refrigerant supply/drain connecting portions at both ends of each of the plurality of narrow tubes are respectively provided on both axial sides of the stator at opposite sides in a diametrical direction with respect to a rotation central axis of the rotor. Note that the phrase “in the stator core” in the specification and the appended claims includes not only the inside of the solid portion of the stator core but also the inside of each slot of the stator core.

In addition, in the superconducting electric motor according to the aspect of the invention, the stator core may have an annular back yoke, a plurality of teeth that radially protrude from a radial end portion of the back yoke, and slots, each of which is provided between two of the teeth that are adjacent in a circumferential direction of the stator, the plurality of superconducting coils may be respectively wound around the plurality of teeth, and the plurality of narrow tubes each may have an in-slot portion that is arranged in a corresponding one of the plurality of slots.

In addition, in the superconducting electric motor according to the aspect of the invention, each of the plurality of in-slot portions may be only in contact with one or two of the superconducting coils in a corresponding one of the slots.

In addition, in the superconducting electric motor according to the aspect of the invention, each of the plurality of in-slot portions may be only in contact with the stator core in a corresponding one of the slots.

In addition, in the superconducting electric motor according to the aspect of the invention, each of the plurality of in-slot portions may be in contact with the stator core and one or two of the superconducting coils in a corresponding one of the slots.

In addition, in the superconducting electric motor according to the aspect of the invention, the plurality of narrow tubes may respectively have core penetrating portions that axially penetrate through at positions spaced apart from each other in a circumferential direction of the stator core.

With the superconducting electric motor according to the aspect of the invention, at least part of each of the plurality of narrow tubes that are provided for the refrigerator and that flow low-temperature refrigerant inside are provided in the stator core, so the plurality of superconducting coils may be efficiently cooled to a desired cryogenic temperature. In addition, the one-side connecting portion and the other-side connecting portion that are refrigerant supply/drain connecting portions at both ends of each of the plurality of narrow tubes are respectively provided on both axial sides of the stator at opposite sides in the diametrical direction with respect to the rotation central axis of the rotor, so the difference in length may be reduced or eliminated, for example in such a manner that the plurality of narrow tubes have a substantially uniform length. Therefore, the stator may be cooled by the plurality of narrow tubes with substantially the same cooling ability. As a result, the superconducting coils at multiple portions of the stator arranged in the circumferential direction may be efficiently cooled to a desired cryogenic temperature while the difference in temperature between the superconducting coils is reduced or eliminated.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an axially cross-sectional view that shows a superconducting electric motor according to a first embodiment of the invention;

FIG. 2 is an enlarged cross-sectional view that is taken along the line II-II in FIG. 1;

FIG. 3 is a view that shows the basic configuration of a refrigerator used in the first embodiment in a state where all narrow tubes extend linearly;

FIG. 4 is a cross-sectional view that is taken along the line IV-IV in FIG. 3;

FIG. 5 is an axially cross-sectional view that shows a superconducting electric motor according to a comparative embodiment that departs from the aspect of the invention;

FIG. 6 is a cross-sectional view that is taken along the line VI-VI in FIG. 5;

FIG. 7 is an axially cross-sectional view that shows a superconducting electric motor according to a second embodiment of the invention;

FIG. 8 is a cross-sectional view that is taken along the line VIII-VIII in FIG. 7;

FIG. 9 is an axially cross-sectional view that shows a superconducting electric motor according to a third embodiment of the invention;

FIG. 10 is a cross-sectional view that is taken along the line X-X in FIG. 9;

FIG. 11 is an axially cross-sectional view that shows a superconducting electric motor according to a fourth embodiment of the invention;

FIG. 12 is an axially cross-sectional view that shows a superconducting electric motor according to a fifth embodiment of the invention;

FIG. 13 is an enlarged cross-sectional view that is taken along the line XIII-XIII in FIG. 12;

FIG. 14 is a view that shows a superconducting electric motor according to a sixth embodiment of the invention and that corresponds to enlarged portion XIV in FIG. 13;

FIG. 15 is a cross-sectional view that is taken along the line XV-XV in FIG. 14;

FIG. 16 is an axially cross-sectional view that shows a superconducting electric motor according to a seventh embodiment of the invention; and

FIG. 17 is a view that corresponds to an enlarged cross-sectional view of a portion of the superconducting electric motor in the circumferential direction, taken along the line XVII-XVII in FIG. 16.

### DETAILED DESCRIPTION OF EMBODIMENTS

### First Embodiment

Hereinafter, an embodiment of the invention will be described in detail with reference to the accompanying drawings. In this description, specific shapes, materials, numeric values, directions, and the like, are only illustrative for easily understanding the aspect of the invention and may be modified appropriately to meet an application purpose, an object, specifications, and the like.

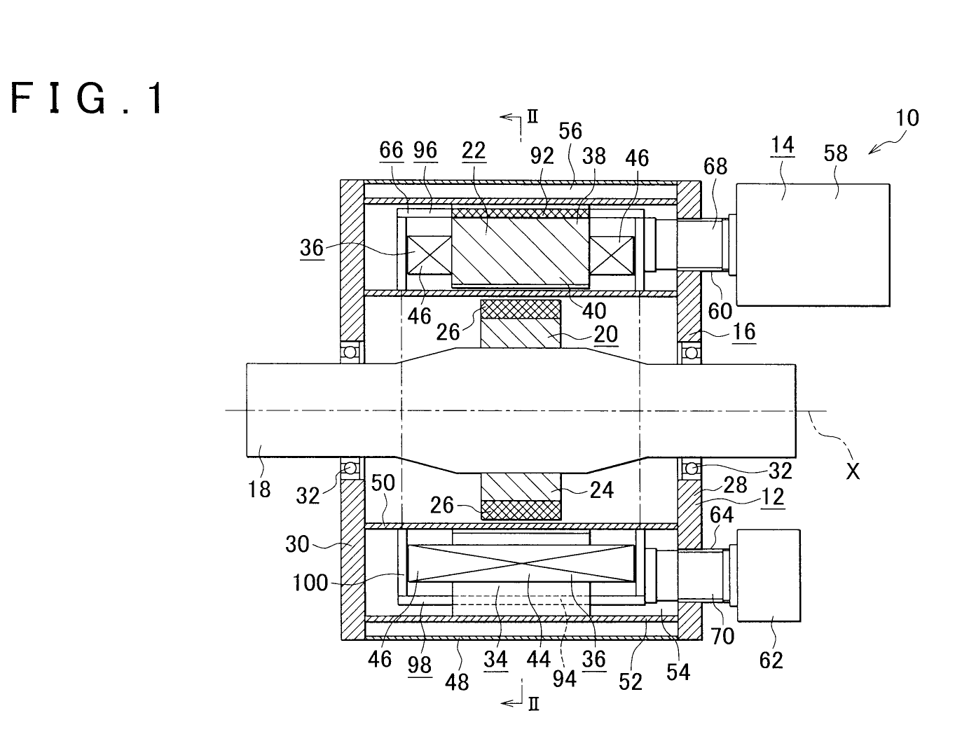

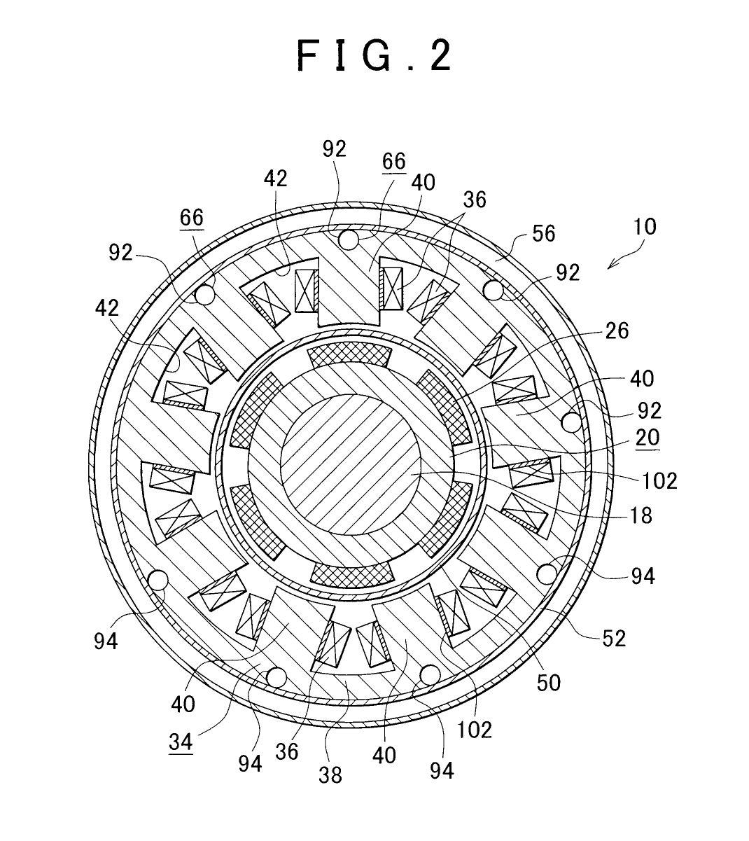

FIG. 1 to FIG. 4 show a superconducting electric motor according to a first embodiment of the invention. As shown in FIG. 1 and FIG. 2, the superconducting electric motor 10 includes a motor body 12 and a refrigerator 14. The refrigerator 14 is used to cool the motor body 12. The motor body 12 includes a motor case 16, a rotary shaft 18 and a rotor 20. The rotary shaft 18 is rotatably supported by the motor case 16. The rotor 20 is fixed to the outer side of the rotary shaft 18 inside the motor case 16 and is rotatably arranged. In addition, the motor body 12 includes a substantially cylindrical stator 22. The stator 22 is fixed to the inner peripheral surface of the motor case 16, and is arranged on the radially outer side of the rotor 20 so as to face the rotor 20. In addition, the refrigerator 14 is fixed to the motor case 16. Note that, in the following description, unless otherwise specified, a direction along the rotation central axis X of the rotary shaft 18 is termed axial direction, a radial direction perpendicular to the rotation central axis X is termed radial direction, and a direction along a circle about the rotation central axis X is termed circumferential direction.

The rotor 20 includes a cylindrical rotor core 24 and a plurality of permanent magnets 26. The rotor core 24 is, for example, formed so that flat rolled magnetic steel sheets are laminated and integrated by crimping, welding, or the like. The permanent magnets 26 are provided at equal intervals on the outer peripheral surface of the rotor core 24. That is, the plurality of (six in the example shown in FIG. 2) permanent magnets 26 are fixed to the outer peripheral surface of the rotor core 24 at equal intervals in the circumferential direction so that the permanent magnets 26 are exposed. The permanent magnets 26 are magnetized in the radial direction, and the magnetized directions of the permanent magnets 26 are alternately varied in the circumferential direction. Therefore, north poles and south poles are alternately arranged on the outer peripheral surface of the rotor 20. However, the permanent magnets 26 of the rotor 20 may not be exposed on the outer peripheral surface, and may be embedded inside near the outer peripheral surface. The thus configured rotor 20 is fixed to the outer peripheral surface of the rotary shaft 18 made of round bar steel material, or the like.

The rotary shaft 18 is rotatably supported by bearings 32 at its both end portions. The bearings 32 are respectively fixed to disc-shaped end plates 28 and 30. The end plates 28 and 30 respectively constitute both end portions of the motor case 16. By so doing, as a revolving magnetic field is generated in the stator 22, the rotor 20 receives the influence of the revolving magnetic field to rotate.

The stator 22 includes a stator core 34 and coils 36. The stator core 34 has a substantially cylindrical shape and serves as a stator iron core. The coils 36 serve as superconducting coils. That is, the stator core 34 has an annular back yoke 38 and a plurality of (nine in the example shown in FIG. 2) teeth 40. The teeth 40 are provided at multiple positions of an inner peripheral end portion at equal intervals in the circumferential direction so as to protrude in the radial direction. The inner peripheral end portion is one radial end portion of the back yoke 38. In addition, the stator core 34 has a plurality of (nine in the example of the drawing) slots 42 that are provided at multiple positions at equal intervals in the circumferential direction. Each of the slots 42 is provided between two of the teeth 40, adjacent in the circumferential direction, at the inner peripheral portion of the back yoke 38. The stator core 34 may be, for example, formed in such a manner that a plurality of substantially annular flat rolled magnetic steel sheets are laminated in the axial direction and are integrally assembled by crimping, adhesion, welding, or the like. Instead, the stator core may be formed in such a manner that a plurality of split cores each having one tooth are arranged continuously in an annular shape and fastened by a cylindrical fastening member from the outer side. The split cores may be formed of dust core.

The plurality of coils 36 formed of a superconducting wire material are respectively wound around the plurality of teeth 40 of the stator core 34 by concentrated winding. Note that the plurality of coils 36 may be respectively wound around the teeth 40 by distributed winding. In addition, the superconducting wire material may have a circular cross-sectional shape or a rectangular cross-sectional shape. For example, the coils 36 may be formed in such a manner that a superconducting wire material that is a flat wire having a rectangular cross-sectional shape is wound in a flatwise manner. For example, the coils 36 may be formed in such a manner that a superconducting wire material is wound around each of the teeth 40 by solenoidal winding or pancake winding. In addition, the superconducting wire material may be suitably, for example, an yttrium series superconducting material or a bismuth series superconducting material. However, the superconducting material that constitutes the superconducting wire material is not limited to these materials; it may be another known superconducting material or a superconducting material that will be developed in the future and that exhibits a superconducting property at a higher temperature.

The superconducting wire material that constitutes each coil 36 may be covered with insulating coating. By so doing, when the superconducting wire material is wound so as to be in closely contact with one another to form each coil 36, electrical insulation is ensured among the turns of each coil 36. Instead, when the superconducting wire material is not covered with insulating coating, the superconducting wire material may be wound into a coil shape while placing insulating paper, insulating film, or the like, in between at the time of forming each coil 36 to thereby ensure electrical insulation among the turns of each coil 36.

Each coil 36 has in-slot portions 44 and two coil end portions 46. The in-slot portions 44 are respectively located in corresponding two of the plurality of slots 42 (FIG. 2) provided at multiple positions of the stator core. The two coil end portions 46 respectively protrude axially outward from both axial end surfaces of the stator core 34. Three of the coils 36, which place two coils 36 in between, are connected in series with one another to constitute any one of U, V and W phase coils. One ends of the phase coils are connected to one another at a neutral point (not shown), and the other ends of the phase coils are respectively connected to phase current introducing terminals (not shown).

In addition, the motor case 16 accommodates the rotor 20 and the stator 22. The motor case 16 has a cylindrical outer peripheral cylindrical portion 48 and the pair of end plates 28 and 30. The outer peripheral edge portions of the pair of end plates 28 and 30 are respectively airtightly connected to both axial end portions of the outer peripheral cylindrical portion 48. The outer peripheral cylindrical portion 48 and the end plates 28 and 30 are, for example, formed of a non-magnetic material, such as stainless steel. Note that the outer peripheral cylindrical portion 48 and the one-side end plate 28 (or 30) may be formed of an integral member.

An inner cylindrical member 50 and an intermediate cylindrical member 52 are provided inside the outer peripheral cylindrical portion 48 concentrically with the rotor 20. The inner cylindrical member 50 and the intermediate cylindrical member 52 each have a cylindrical shape. Both axial end portions of each of the inner cylindrical member 50 and intermediate cylindrical member 52 are respectively airtightly coupled to the inner surfaces of the end plates 28 and 30. The inner cylindrical member 50 is desirably formed of a non-metal material (for example, FRP, or the like) that does not interfere with passage of a magnetic field and that is electrically not conductive. More desirably, the inner cylindrical member 50 is formed of a material having a low thermal conductivity. Note that the inner cylindrical member 50 just needs to have the function of passing a magnetic field and the function of being able to retain vacuum at a space sealing portion, including the inner cylindrical member 50, as basic functions, and is not limited to the one using an electrically non-conductive material. For example, a non-magnetic material having a low electrical conductivity (for example, stainless steel, or the like) may also be used as the material that constitutes the inner cylindrical member 50. On the other hand, the intermediate cylindrical member 52 is desirably formed of a material having a low thermal conductivity (for example, FRP, or the like), and is more desirably formed of a non-magnetic material having a low thermal conductivity.

The inner cylindrical member 50 has an inside diameter that is slightly larger than the diameter of the outermost circumcircle of the rotor 20. A gap is formed between the inner cylindrical member 50 and the outer peripheral surface of the rotor 20. In addition, a first vacuum chamber 54 is provided between the inner cylindrical member 50 and the intermediate cylindrical member 52. The first vacuum chamber 54 is a cylindrical space. The stator 22 that includes the coils 36 are accommodated in the first vacuum chamber 54. The outer peripheral surface of the stator core 34 that constitutes the stator 22 is fixed to the inner peripheral surface of the intermediate cylindrical member 52.

The first vacuum chamber 54 is maintained in a vacuum condition in such a manner that, after the superconducting electric motor 10, including the refrigerator 14 described in detail later, is assembled, air is evacuated through an air vent hole (not shown) formed in at least any one of members, such as the end plates 28 and 30 and the outer peripheral cylindrical portion 48, that adjoin an external space and one or both of the first vacuum chamber 54 and a second vacuum chamber 56. In this way, the first vacuum chamber 54 is defined by the inner cylindrical member 50, which is not in contact with the coils 36 and the stator 22, and the intermediate cylindrical member 52 having a low thermal conductivity, and the inside of the first vacuum chamber 54 is evacuated. By so doing, it is possible to enhance heat insulation to the stator 22, including the coils 36, accommodated in the first vacuum chamber 54.

Furthermore, the second vacuum chamber 56 is formed between the intermediate cylindrical member 52 and the motor case 16. The second vacuum chamber 56 is formed of a cylindrical space. The second vacuum chamber 56, as well as the first vacuum chamber 54, is in a vacuum condition. A hole that provides fluid communication between the first vacuum chamber 54 and the second vacuum chamber 56 is desirably provided for the intermediate cylindrical member 52. By so doing, the stator 22, which includes the coils 36 and which is accommodated in the first vacuum chamber 54, is isolated from the outside of the motor additionally by the second vacuum chamber 56. Thus, it is possible to further enhance heat insulation effect to the stator 22 including the coils 36.

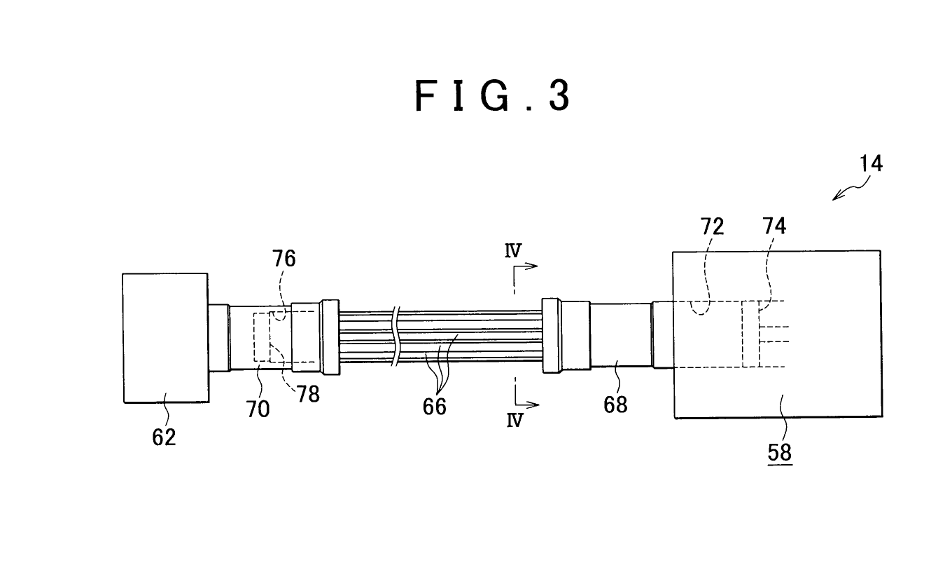

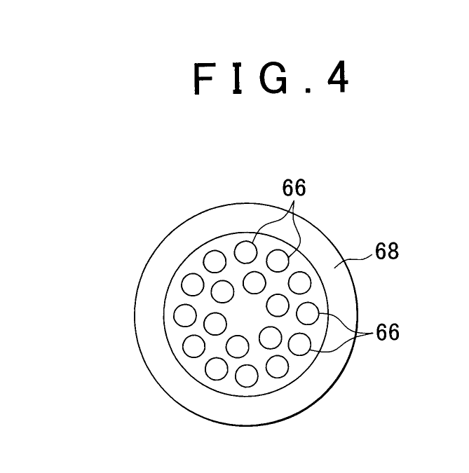

In addition, the refrigerator 14 is fixed to the motor body 12 that constitutes the superconducting electric motor 10. Next, the basic configuration of the refrigerator 14 will be described with reference to FIG. 3 and FIG. 4. FIG. 3 is a view that shows the basic configuration of the refrigerator 14 used in the present embodiment in a state where all narrow tubes 66 extend linearly. FIG. 4 is a cross-sectional view that is taken along the line IV-IV in FIG. 3. The refrigerator 14 is a free-piston Stirling cooler (FPSC). The refrigerator 14 has the plurality of narrow tubes 66 that are used to flow refrigerant gas. That is, the refrigerator 14 includes a pressure vibration source 58, a cool storage device 68, a phase controller 62, a second piston accommodating portion 70 and the plurality of narrow tubes 66. The pressure vibration source 58 is provided at one end of the refrigerator 14, and serves as a refrigerator drive source. The cool storage device 68 is called cold head, and one end portion of the cool storage device 68 is fixed to the pressure vibration source 58. The phase controller 62 is provided at the other end of the refrigerator 14. One end portion of the second piston accommodating portion 70 is fixed to the phase controller 62. The plurality of narrow tubes 66 are connected between the cool storage device 68 and the second piston accommodating portion 70. The plurality of narrow tubes 66 serve as a plurality of cooling portions, and are formed of a material having a high thermal conductivity. A cool storage medium (not shown) is provided inside the cool storage device 68. In addition, the cool storage device 68 and the second piston accommodating portion 70 have a heat insulation structure such that the outer sides of the cool storage device 68 and second piston accommodating portion 70 are covered with a heat insulation material.

The refrigerator 14 has a first piston 74. The first piston 74 linearly reciprocates in the cylinder 72 of the pressure vibration source 58, and serves as a drive piston. The space in the cylinder 72 is in fluid communication with the insides of the plurality of narrow tubes 66 via the inside of the cool storage device 68. In addition, the refrigerator 14 also has a second piston 78. The second piston 78 linearly reciprocates in the cylinder 76 of the second piston accommodating portion 70, and is called an expansion piston or a driven piston. The space in the cylinder 76 is in fluid communication with the insides of the plurality of narrow tubes 66 that serve as a low-temperature-side heat exchanging portion. Refrigerant gas (for example, helium gas) is filled in the internal space between the first piston 74 and the second piston 78, including the plurality of narrow tubes 66. That is, the narrow tubes 66 each are configured to flow low-temperature refrigerant gas inside.

In addition, the pressure vibration source 58 and the second piston accommodating portion 70 are arranged so as to face each other such that the directions in which the pistons 74 and 78 move are along the same straight line. The first piston 74 is, for example, connected to a mover of a linear motor, or the like, (not shown) that constitutes the pressure vibration source 58, and the linear motor is used to reciprocate the first piston 74 inside the cylinder 72. With the reciprocation of the first piston 74, the pressure of refrigerant gas varies within the cylinder 72 of the pressure vibration source 58. Owing to the pressure variation, the second piston 78 that is suspended by a spring formed of a coil spring, a leaf spring, or the like, (not shown) inside the phase controller 62 also dependently reciprocates. A phase difference between a pressure variation and a positional variation in refrigerant gas may be adjusted by the weight of the spring (not shown), the weight of the second piston 78 and a pressure variation resulting from the reciprocation of the first piston 74. In addition, a space that relieves a pressure variation resulting from the reciprocation of the second piston 78 is provided inside the phase controller 62. By so doing, the space is in fluid communication with the inside of the cylinder 76, in which the second piston 78 is arranged, to thereby make it possible to adjust the phase difference between the pressure variation and positional variation of refrigerant gas.

With the reciprocation of the first piston 74, refrigerant gas adiabatically expands and is cooled at a portion of the second piston accommodating portion 70 near the end portions of the narrow tubes 66, so refrigerant gas flowing through the insides of the narrow tubes 66 is also cooled. In this way, compression and expansion of refrigerant gas are repeated between the first piston 74 and the second piston 78 to cool the narrow tubes 66 through which refrigerant gas flows.

The refrigerator 14 has cooling performance such that the coils 36 made of a superconducting wire material may be cooled to a desired cryogenic temperature (for example, about 70 K) at which the coils 36 exhibit a superconducting property. The cooling temperature of the refrigerator 14 may be adjusted by controlling the stroke of the first piston 74. Therefore, the stroke of the first piston 74 is controlled by a control unit (not shown). The control unit may be configured to control the cooling temperature of the refrigerator 14 according to a load of the superconducting electric motor 10 (FIG. 1). For example, the cooling temperature may be decreased with an increase in the load of the superconducting electric motor 10. When the superconducting electric motor 10 is mounted on an electromotive vehicle, such as an electric vehicle, as a driving source for propelling the vehicle, the refrigerator 14 is desirably smaller and lighter because of a limited installation space and a reduction in vehicle weight. When the FPSC is used as the refrigerator 14 as described above, the refrigerator 14 may be reduced in size and weight.

In the present embodiment, the refrigerator 14 having such a basic configuration is fixed to the motor body 12 (FIG. 1). That is, as shown in FIG. 1, in the superconducting electric motor 10, a cylindrical first bracket 60 adjacent to the pressure vibration source 58 that constitutes the refrigerator 14 is fixed to a circumferential portion (upper portion in FIG. 1) of the end plate 28 located at one axial side (right side in FIG. 1), and a cylindrical second bracket 64 adjacent to the phase controller 62 that constitutes the refrigerator 14 is fixed to the opposite side (lower side in FIG. 1) of the end plate 28 in the diametrical direction of the rotary shaft 18 with respect to the pressure vibration source 58. In addition, one end portion of the cool storage device 68 and one end portion of the second piston accommodating portion 70 respectively protrude into the first vacuum chamber 54 via the inside of the first bracket 60 and the inside of the second bracket 64.

In addition, as shown in FIG. 2, the plurality of narrow tubes 66, which serve as the low-temperature-side heat exchanging portion, each have a first core penetrating portion 92 and a second core penetrating portion 94 that are provided at two portions in the longitudinal center portion of the narrow tube 66. The plurality of core penetrating portions 92 and 94 are respectively provided at multiple positions (eight positions in the case of the example shown in the drawing) of the back yoke 38 in the circumferential direction of the back yoke 38, that constitutes the stator core 34, so as to axially penetrate through the back yoke 38. The circumferential positions at which the plurality of core penetrating portions 92 and 94 are provided are same as the circumferential center position of some of the teeth 40.

Cold is transferred from the above narrow tubes 66 to the coils 36 via the inside of the stator core 34 to cool the coils 36. In this way, the plurality of narrow tubes 66 are respectively arranged such that the center portions penetrate through the multiple portions of the stator core 34 arranged in the circumferential direction, so a part or whole of the plurality of narrow tubes 66 are formed such that the center portions are bent into a substantially gate-like shape or a crank shape. That is, each of the plurality of narrow tubes 66 has a first straight portion 96, a second straight portion 98 and a coupling portion 100. The first straight portion 96 has the first core penetrating portion 92. The first core penetrating portions 92 penetrate through first portions of the back yoke 38 arranged in the circumferential direction. The second straight portion 98 has the second core penetrating portion 94. The second core penetrating portions 94 penetrate through second portions of the back yoke 38 at positions different from the first portions in the circumferential direction, such as a positions at substantially the opposite sides in the diametrical direction of the stator core 34 with respect to the first portions, in the stator core 34. The coupling portion 100 couples the first and second straight portions 96 and 98 so as to provide fluid communication between the insides of the first and second straight portions 96 and 98. For example, at least parts of each narrow tube 66, having the core penetrating portions 92 and 94, are made of a magnetic material. Even when the core penetrating portions 92 and 94 are made of a magnetic material in this way, the core penetrating portions 92 and 94 are arranged at positions at which the core penetrating portions 92 and 94 are less likely to influence the magnetic path of a magnetic flux that passes through the inside of the stator core 34 during usage of the superconducting electric motor 10, so it is possible to reduce the influence on motor performance. Therefore, in the present embodiment, the core penetrating portion 92 (or 94) of each narrow tube 66 is inserted in a through hole that axially penetrates through the stator core 34. In addition, each through hole is in thermal contact with the corresponding core penetrating portion 92 (or 94). That is, each core penetrating portion 92 (or 94) is inserted in a corresponding one of the through holes so as to be in contact with the corresponding through hole, or so as to be in contact with the corresponding through hole via a heat conductive material.

In addition, the core penetrating portions 92 and 94 in the different narrow tubes are provided at different positions of the stator core 34 in the circumferential direction. Therefore, the number of the narrow tubes 66 is half the total number of the core penetrating portions 92 and 94. In addition, the length of each of the core penetrating portions 92 and 94 is equal among all the core penetrating portions 92 and 94. That is, the length of each of the core penetrating portions 92 and 94 of the plurality of narrow tubes 66 that constitute the refrigerator 14 and that penetrate through the stator core 34 is equal among all the plurality of narrow tubes 66. Note that the first core penetrating portion 92 of the first straight portion 96 that constitutes one narrow tube 66 is indicated by the diagonal grid pattern in FIG. 1.

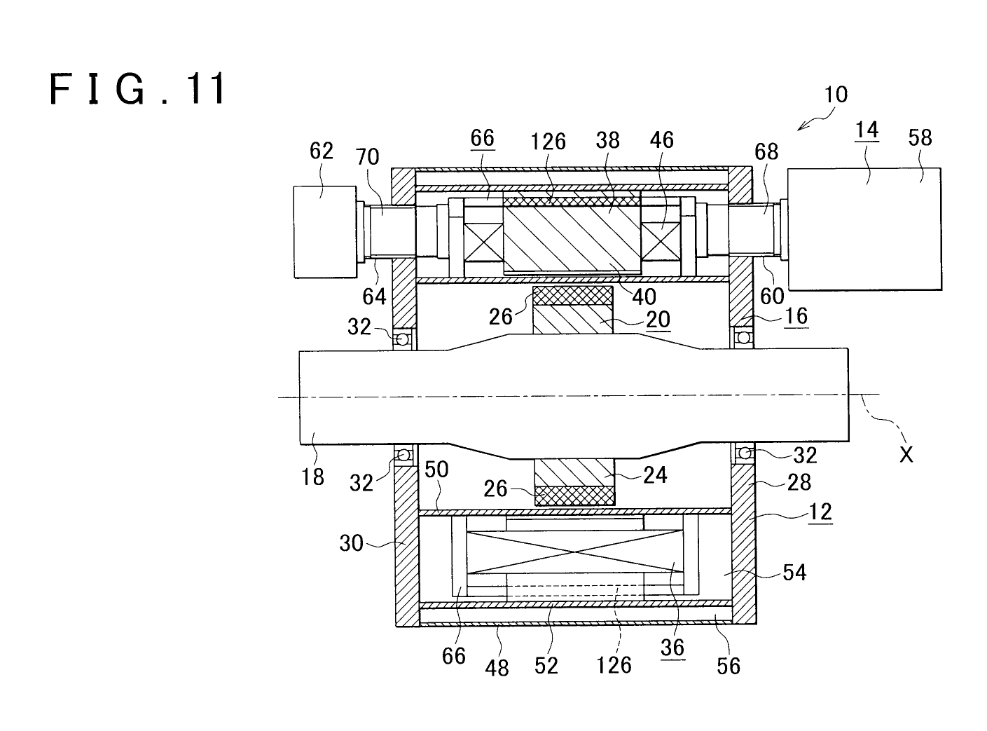

As described above, the pressure vibration source 58 and the second piston accommodating portion 70 are arranged on one axial side of the motor body 12. However, the present embodiment is not limited to this configuration. As shown in FIG. 11 described later, the pressure vibration source 58 and the second piston accommodating portion 70 may be provided at positions different in the circumferential direction, such as positions along the same straight line and positions at opposite sides in the diametrical direction, on the outer sides of the pair of end plates 28 and 30, that is, on both sides of the motor body 12. For example, the pressure vibration source 58 and the second piston accommodating portion 70 may be provided at positions different in the circumferential direction from each other, such as positions at opposite sides in the diametrical direction, that is, positions that are symmetrical with respect to the rotary shaft 18, on both axial sides of the motor body 12.

With the above configuration, the low-temperature-side heat exchanging portion is formed of the plurality of narrow tubes 66. In addition, a high-temperature-side heat exchanging portion is formed of an end portion of the second piston accommodating portion 70, arranged outside of the motor case 16. The above refrigerator 14 includes the pressure vibration source 58, the high-temperature-side heat exchanging portion, the cool storage device 68, the low-temperature-side heat exchanging portion and the second piston 78 (FIG. 3).

With the above superconducting electric motor 10, the narrow tubes 66 that are provided for the refrigerator 14 and that flow low-temperature refrigerant gas inside each have the core penetrating portions 92 and 94 that are provided so as to penetrate through the stator core 34. Therefore, the narrow tubes 66 are configured so as to be in thermal contact with the coils 36. Thus, different from the configuration that a heat conductive material that transfers cold generated by a refrigerator is brought into contact with an opposite end portion of the stator core with respect to the superconducting coils to cool the superconducting coils, according to the present embodiment, the narrow tubes 66 that serve as heat conductive materials are brought close to the coils 36 to make it possible to efficiently cool the coils 36 to a desired cryogenic temperature. Together with this, the stator core 34 having a large thermal capacity functions as a buffer during heat transfer to thereby effectively prevent a situation that cooling using the narrow tubes 66 cannot follow an increase in the temperature of the coils 36 even during a high load or in a transitional motor operating state. By so doing, it is possible to stably continue cooling the coils 36. Thus, a stable superconducting condition may be effectively generated. Furthermore, different from the configuration that a heat conductive material is arranged adjacent to the superconducting coils of the stator core to cool the superconducting coils, the installation position flexibility and mountability of the narrow tubes 66 that serve as heat conductive materials are improved. Note that the “thermal contact” in this specification includes not only direct contact between members that mutually transfer heat but also contact via a member having a thermal conductivity. Furthermore, according to the present embodiment, the length of each narrow tube 66 is substantially equal, so refrigeration performance may be improved. That is, the performance of the refrigerator 14 requires that pressure variations in the low-temperature portion heat exchanger and the piston arrangement spaces and positional variations in refrigerant gas serving as working gas are maintained at appropriate phase angles. If it is assumed that a variation in phase angle in one narrow tube, that is, a variation in phase angle that varies in one narrow tube, has been optimized, the variation in phase angle for a narrow tube having another length deviates from an optimal value. Therefore, all the narrow tubes have substantially the same length to thereby make it possible to obtain a phase angle close to an optimal value in all the narrow tubes and to improve refrigeration performance. For example, in the present embodiment, the length of each narrow tube 66 is substantially equal by a combination of the first core penetrating portion 92 and the second core penetrating portion 94. Therefore, refrigeration performance may be improved.

In addition, each narrow tube 66 has the core penetrating portions 92 and 94 that extend in the axial direction of the stator 22 in the stator core 34. Generally, a superconducting coil has an extremely poor heat conductivity as compared with a copper wire that constitutes the coil of an electric motor used at normal room temperatures, so it is difficult to uniformly cool the superconducting coil. However, according to the above configured present embodiment, different from the case of a configuration that, for example, only the coil end portions 46 are cooled in the coils 36, the in-slot portions 44 of the coils 36 may be efficiently cooled, so the whole of the coils 36, which serve as superconducting coils, are easily cooled further uniformly. That is, the coils 36 may be cooled while reducing a biased temperature distribution among the whole of the coils 36.

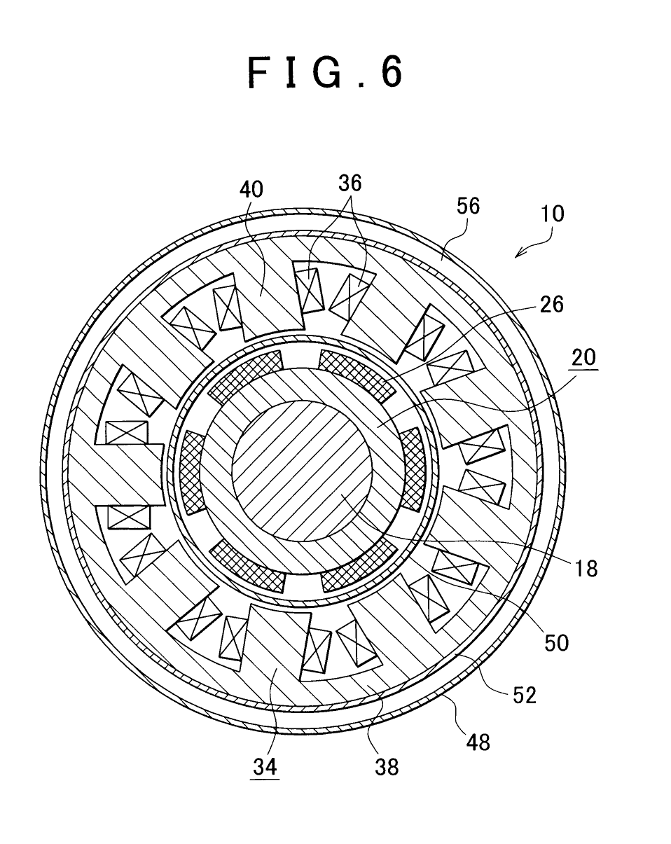

In addition, in the present embodiment, as shown in FIG. 2, an insulator 102 having an electrical insulation property is provided at a portion facing the corresponding coil 36 around each tooth 40. Each coil 36 is in thermal contact with a corresponding one of the teeth 40 via the insulator 102. In this case, the thickness of each insulator 102 may be reduced as much as possible or each insulator 102 may be made of a material having a high thermal conductivity, such as resin that contains a filler, such as silica, alumina and a nonmagnetic material having a high thermal conductivity. By so doing, cooling performance for cooling the coils 36 may be improved. Note that, in the example of the drawing, the number of the teeth 40 is nine, that is, odd number, so not all the plurality of core penetrating portions 92 and 94 are provided at equal intervals in the circumferential direction of the back yoke 38. However, for example, when the number of the teeth 40 is set to even number, and the core penetrating portions 92 and 94 of the narrow tubes 66 are provided at the same positions in the circumferential direction as the teeth 40 in the back yoke 38, the core penetrating portions may be provided at multiple positions of the stator core 34 at equal intervals in the circumferential direction. Note that, in the present embodiment, each insulator 102 is provided around a corresponding one of the teeth 40; instead, as long as each coil 36 that serves as a superconducting coil is covered with insulating coating and the contact between each coil 36 and a corresponding one of the teeth 40 may be ensured, the insulators may be omitted as shown in FIG. 6 described later. In addition, in the present embodiment, in order to ensure heat transfer performance, the coils 36 are brought into contact with the insulators 102 and the insulators 102 are brought into contact with the teeth 40 to ensure the contact therebetween. Thus, the insulators 102 may be omitted and heat conductive materials, such as epoxy resin adhesive agent containing a filler may be used instead.

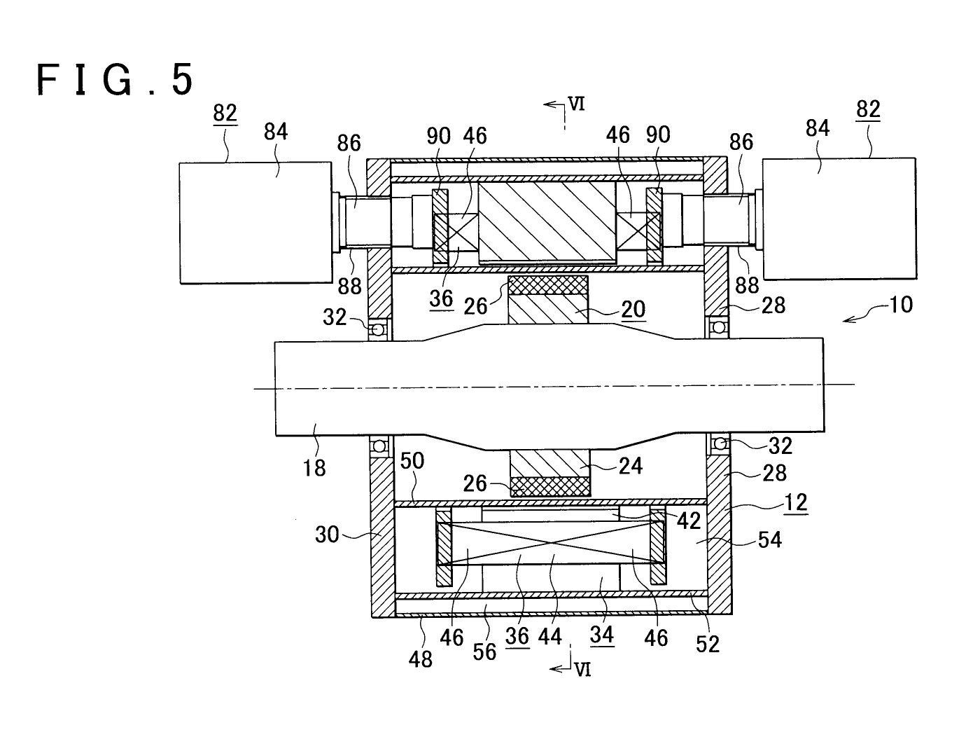

FIG. 5 is an axially cross-sectional view that shows a superconducting electric motor according to a comparative embodiment that departs from the aspect of the invention. FIG. 6 is a cross-sectional view that is taken along the line VI-VI in FIG. 5. The superconducting electric motor 10 according to the comparative embodiment shown in FIG. 5 and FIG. 6 differs from that of the structure of the present embodiment in that a pair of refrigerators 82 are provided on both sides of the motor body 12 instead of the refrigerator 14 (FIG. 1, and the like). That is, different from the refrigerator 14, each refrigerator 82 is an FPSC with no narrow tube that is used to flow refrigerant, and includes a gas compressor 84 that serves as a pressure vibration source and a cool storage device 86 that serves as a cooling portion connected to the gas compressor 84. In addition, the distal end portion of each cool storage device 86 is in contact with a disc-shaped heat transfer member 90 through the inside of a cylindrical bracket 88 fixed to the end plate 28 or 30. One-side surface of each heat transfer member 90 is in contact with the axially outer end portions of the coil end portions 46.

Each refrigerator 82 cools the coils 36 via the cool storage device 86 and the heat transfer member 90 in such a manner that a piston (not shown) reciprocates in a cylinder (not shown) provided inside the gas compressor 84 to repeatedly compress and expand refrigerant gas. With the above configuration as well, the coils 36 may be cooled; however, there is room for improvement in terms of easily cooling the whole of the coils 36 uniformly. In addition, each heat transfer member 90 transfers heat to a target to be cooled only using solid matter, which is different from the configuration that the narrow tubes that flow refrigerant inside are used, so there is room for improvement in terms of cooling the plurality of coils 36 uniformly. According to the above present embodiment, any of these points that should be improved may be improved.

Note that, in the above description, the refrigerator 14 is a passive refrigerator in which the second piston 78 is dependently displaced with a displacement of the first piston 74. However, a refrigerator may be provided with a second driving source, such as a linear motor, that forcibly displaces the second piston 78 at the side of the phase controller 62 so that, when the first piston 74 is reciprocally displaced, the second piston 78 is displaced at a phase shifted about 90 to 120 degrees from the phase of a cycle of the reciprocal displacement of the first piston 74. In this case, an active refrigerator is configured, and further energy saving may be achieved.

In addition, a refrigerator, other than an FPSC, may be used as the refrigerator 14. For example, when there is a small limitation on the installation space and weight of a refrigerator, such as when the superconducting electric motor 10 is used as a power source for a large-sized mobile unit, such as an electric train and a ship, or when a power source for a machine of which the installation site is fixed, a large and heavy refrigerator may be used as long as the refrigerator has a plurality of narrow tubes and has cooling performance such that a target to be cooled may be cooled to a cryogenic temperature (for example, about 70 K).

In addition, a Stirling pulse tube refrigerator, a GM refrigerator, or the like, each having narrow tubes, may be used as the refrigerator. For example, in the pulse tube refrigerator, instead of the second piston accommodating portion 70, a pulse tube connected between the narrow tubes 66 and the phase controller 62 is used. No piston is provided inside the pulse tube. In the pulse tube refrigerator, the structure of vibrating pressure by opening and closing a valve may be used as the pressure vibration source 58. In addition, for the GM refrigerator, a rotary compressor or the structure of vibrating pressure by opening and closing a valve may be used in the FPSC refrigerator as the pressure vibration source 58. In addition, in this structure, the phase controller 62 is omitted and a displacer that serves as an expansion piston is reciprocally displaceably provided for the expansion/compression unit connected to the end portions of the narrow tubes 66, which are opposite to the pressure vibration source 58. The displacer is, for example, reciprocated by a motor, such as a stepping motor, during operation of the refrigerator. In this way, according to the aspect of the invention, various types of refrigerators may be used as the refrigerator as long as the refrigerators have narrow tubes that flow refrigerant inside.

### Second Embodiment

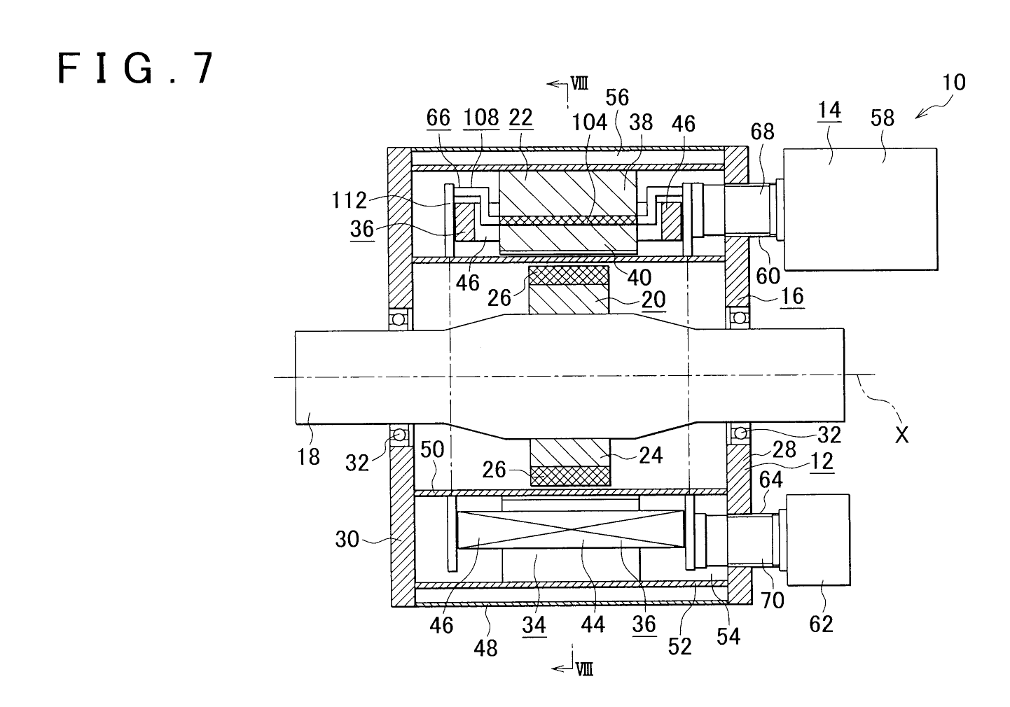

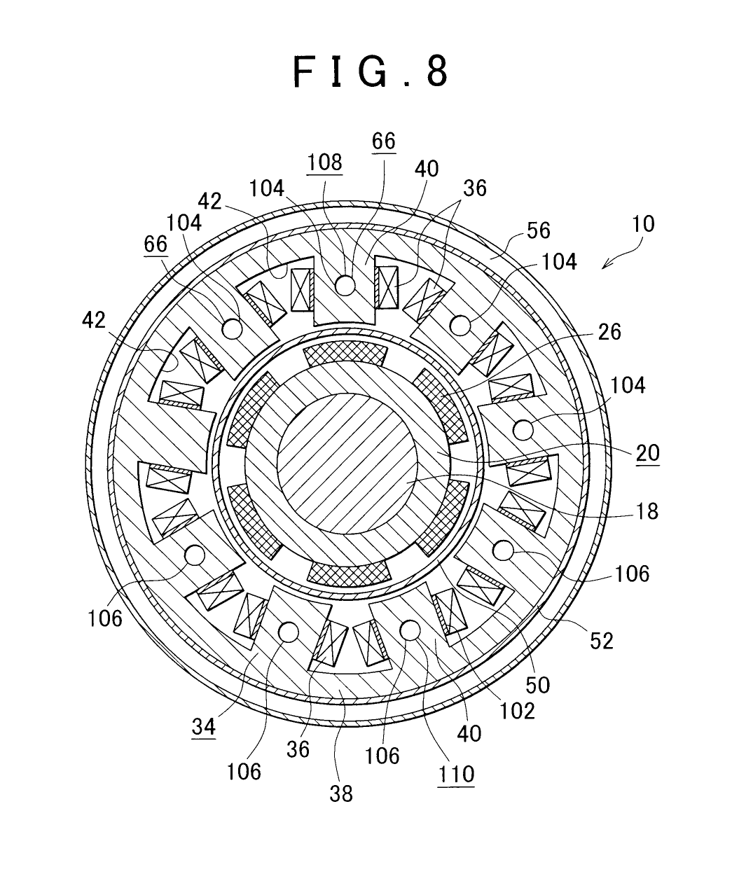

FIG. 7 is an axially cross-sectional view that shows a superconducting electric motor according to a second embodiment of the invention. FIG. 8 is a cross-sectional view that is taken along the line VIII-VIII in FIG. 7.

The superconducting electric motor 10 according to the present embodiment differs from that of the first embodiment in that the plurality of narrow tubes 66 each have a crank-shaped portion that is formed to bend in a crank shape instead of the straight portions 96 and 98 (see FIG. 1, and the like). That is, the plurality of narrow tubes 66 each have a first core penetrating portion 104 and a second core penetrating portion 106 that are provided at two positions in the longitudinal center portion of the narrow tube 66. The core penetrating portions 104 and 106 are provided in some of the plurality of teeth 40 of the stator core 34 so as to axially penetrate through substantially the center portion of corresponding teeth 40 of the stator core 34.

That is, each of the plurality of narrow tubes 66 has a first crank-shaped portion 108, a second crank-shaped portion 110 and a coupling portion 112 (FIG. 7). The first crank-shaped portion 108 has the first core penetrating portion 104 that axially penetrates through the teeth 40. The second crank-shaped portion 110 has the second core penetrating portion 106 that axially penetrates through another one of the teeth 40, provided at substantially the opposite side in the diametrical direction of the stator 22 with respect to the above tooth 40 through which the first crank-shaped portion 108. The coupling portion 112 couples the first and second crank-shaped portions 108 and 110 so as to provide fluid communication between the insides of the first and second crank-shaped portions 108 and 110. Each of the crank-shaped portions 108 and 110 has radial portions and axial portions. The radial portions extend radially outward from both ends of each straight portion having the core penetrating portion 104 or 106. The axial portions each are coupled between the radially outer end of the radial portion and the coupling portion 112 or between the radially outer end of the radial portion and one of the cool storage device 68 and the second piston accommodating portion 70. The axial portions extend in the axial direction. In addition, the plurality of core penetrating portions 104 and 106 of the different narrow tubes 66 are provided so as to penetrate through the different teeth 40. Therefore, the number of the narrow tubes 66 is about half the total number of the teeth 40. In addition, in the present embodiment, the core penetrating portion 104 (or 106) of each narrow tube 66 is inserted in a through hole that axially penetrates through the stator core 34. In addition, each through hole is in thermal contact with the corresponding core penetrating portion 104 (or 106). That is, each core penetrating portion 104 (or 106) is inserted in a corresponding one of the through holes so as to be in contact with the corresponding through hole or so as to be in contact with the corresponding through hole via a heat conductive material. Note that the first core penetrating portion 104 of the first crank-shaped portion 108 that constitutes one narrow tube 66 is indicated by the diagonal grid pattern in FIG. 7. For example, at least portions of each narrow tube 66, having the core penetrating portions 104 and 106, are made of a nonmagnetic material. In the present embodiment, the core penetrating portions 104 and 106 are arranged at positions at which the core penetrating portions 104 and 106 are highly likely to influence the magnetic path of a magnetic flux that passes through the inside of the stator core 34 during usage of the superconducting electric motor 10. However, when the core penetrating portions 104 and 106 are made of a nonmagnetic material as described above, it is possible to effectively prevent an excessive decrease in motor performance irrespective of the arrangement positions of the core penetrating portions 104 and 106.

In the case of the above present embodiment as well, the coils 36 formed of a superconducting wire material are efficiently cooled to a desired cryogenic temperature, a stable superconducting condition may be effectively generated even during a high load or in a transitional motor operating state, and, furthermore, the installation position flexibility and mountability of the narrow tubes 66 that serve as heat conductive materials are improved. In addition, in the case of the present embodiment as well, the length of each narrow tube 66 is substantially equal by a combination of the first core penetrating portion 104 and the second core penetrating portion 106, so refrigeration performance may be improved. Note that, in the example shown in FIG. 7, portions of the crank-shaped portions 108 and 110, protruding from both axial ends of the stator core 34, are arranged inside the coil end portions 46 so as not to be in contact with the coils 36. However, the crank-shaped portions 108 and 110 are brought into contact with the coil end portions 46 to make it possible to improve cooling performance for cooing the coils 36. The other configuration and function are the same as those of the first embodiment shown in FIG. 1 to FIG. 4.

### Third Embodiment

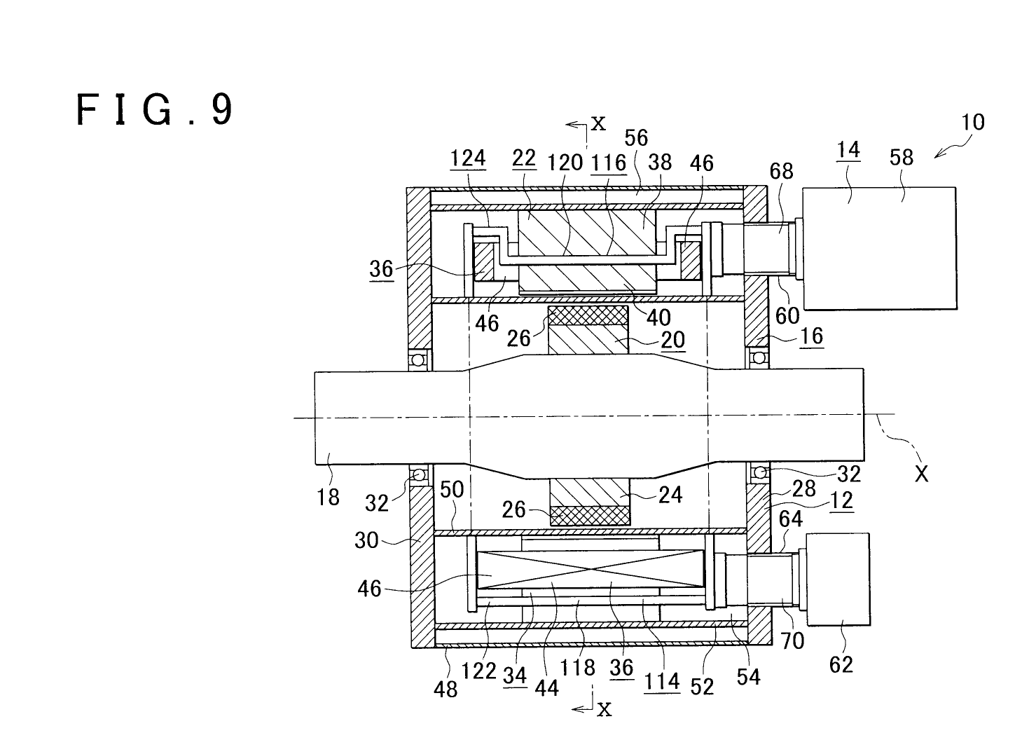

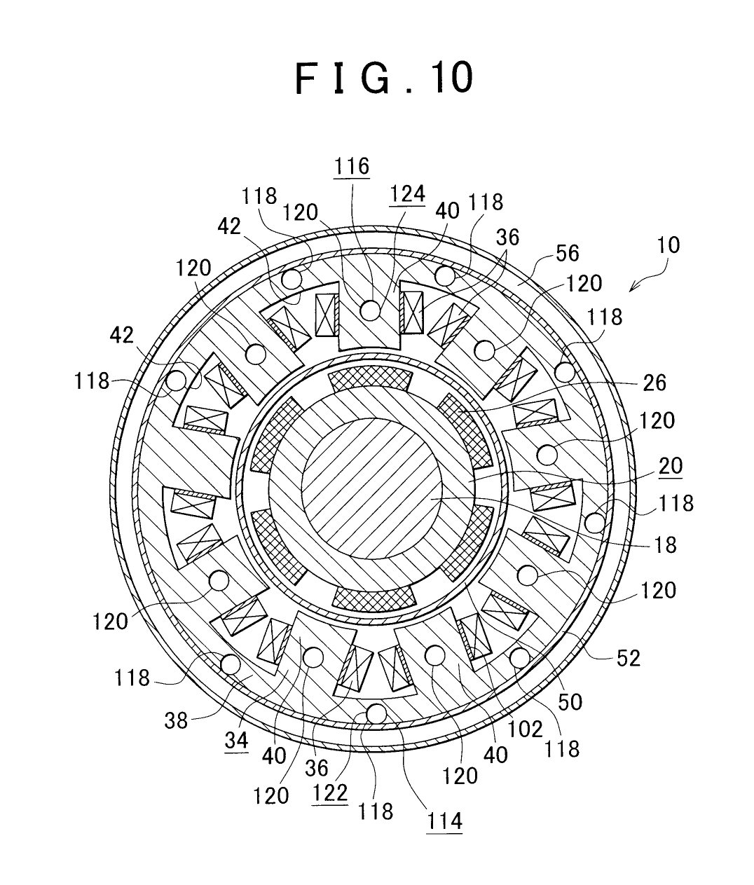

FIG. 9 is an axially cross-sectional view that shows a superconducting electric motor according to a third embodiment of the invention. FIG. 10 is a cross-sectional view that is taken along the line X-X in FIG. 9.

The superconducting electric motor 10 according to the present embodiment has a configuration that combines the second embodiment shown in FIG. 7 and FIG. 8 with the first embodiment shown in FIG. 1 to FIG. 4. That is, in the third embodiment, the refrigerator 14 has first narrow tubes 114 and second narrow tubes 116 that flow low-temperature refrigerant gas inside. The plurality of first narrow tubes 114 and the plurality of second narrow tubes 116 are provided. Each of the first narrow tubes 114 has a configuration similar to that of each of the narrow tubes 66 (FIG. 1 and FIG. 2) that constitute the refrigerator 14 of the first embodiment, and has two first core penetrating portions 118 that are provided so as to axially penetrate through at two positions different in the circumferential direction, such as positions at substantially the opposite sides in the diametrical direction of the back yoke 38 (FIG. 10). The first core penetrating portions 118 are respectively provided at the same circumferential positions of the back yoke 38 as the circumferential center portions of some of the plurality of slots 42.

In addition, each of the second narrow tubes 116 has a configuration similar to that of each of the narrow tubes 66 (FIG. 7 and FIG. 8) that constitute the refrigerator 14 of the second embodiment, and has two second core penetrating portions 120 that are provided so as to axially penetrate through two teeth 40 provided at two positions different in the circumferential direction, such as positions at substantially the opposite sides in the diametrical direction of the stator core 34. The first core penetrating portion 118 is provided at the center portion of each straight portion 122, and the second core penetrating portion 120 is provided at the center portion of each crank-shaped portion 124.

In addition, materials that constitute the core penetrating portions are varied on the basis of the arrangement positions of the core penetrating portions of the narrow tubes. That is, at least portions of each first narrow tube 114, having the first core penetrating portions 118, are made of a magnetic material, and at least portions of each second narrow tube 116, having the second core penetrating portions 120, are made of a nonmagnetic material. When the narrow tubes 114 and 116 are provided so as to penetrate through the multiple portions of the stator core 34 in this way, if the core penetrating portions 120 provided for the teeth 40 are made of a magnetic material, the core penetrating portions 120 may influence a magnetic flux that passes through the inside of the stator core 34 during usage of the superconducting electric motor 10 to decrease motor performance. In contrast to this, when the portions having the second core penetrating portions 120 arranged in the teeth 40 are made of a nonmagnetic material, it is possible to effectively prevent an excessive decrease in motor performance due to the second core penetrating portions 120. However, the present embodiment is not limited to the configuration that materials that constitute the core penetrating portions are varied on the basis of the arrangement positions of the core penetrating portions of the narrow tubes; all the portions having the core penetrating portions may be made of the same material.

In the case of the above present embodiment, it is possible to further improve cooling performance for cooling the coils 36 as compared with the above described embodiments. The other configuration and function are the same as those of the first embodiment shown in FIG. 1 to FIG. 4 or those of the second embodiment shown in FIG. 7 and FIG. 8. For example, in the case of the present embodiment, the length of each of the narrow tubes 114 and 116 is substantially equal by the first narrow tubes 114 each having a combination of two first core penetrating portions 118 and the second narrow tubes 116 each having a combination of two second core penetrating portions 120, so refrigeration performance may be improved. Note that, in the present embodiment, the narrow tubes 114 that penetrate through the back yoke 38 and the narrow tubes 116 that penetrate through the teeth 40 are provided separately. However, one narrow tube may have both a penetrating portion that penetrates through the back yoke 38 and a penetrating portion that penetrates through one of the teeth 40. In this case, the length of each of the plurality of narrow tubes is made equal or is brought close to the same length.

### Fourth Embodiment

FIG. 11 is an axially cross-sectional view that shows a superconducting electric motor according to a fourth embodiment of the invention. The present embodiment differs from the first embodiment shown in FIG. 1 to FIG. 4 in that the pressure vibration source 58 and the second piston accommodating portion 70 that constitute the refrigerator 14 are arranged on both axial sides of the motor body 12. That is, the pressure vibration source 58 and the second piston accommodating portion 70 are provided along a common straight line parallel to the rotation central axis X of the rotary shaft 18 respectively on the outer sides of the pair of end plates 28 and 30, that is, on both sides of the motor body 12. In addition, the center portions of the narrow tubes 66 respectively have core penetrating portions 126 that axially penetrate through multiple different portions of the back yoke 38 of the stator core 34 in the circumferential direction. Accordingly, the center portions of part or whole of the plurality of narrow tubes 66 are formed so as to be bent into a substantially crank shape, or the like. In this way, according to the aspect of the invention, the arrangement relationship between the pressure vibration source 58 and the second piston accommodating portion 70 that constitute the refrigerator 14 may be varied in different ways. The other configuration and function are the same as those of the first embodiment shown in FIG. 1 to FIG. 4.

Note that, in the above embodiments, the aspect of the invention is applied to the inner rotor structure in which the stator is arranged on the radially outer side of the rotor so as to face the rotor. However, the aspect of the invention is not limited to this configuration. The aspect of the invention may be applied to an outer rotor structure in which the stator is arranged on the radially inner side of the rotor so as to face the rotor. In this case, the superconducting coils are wound at an outer peripheral end portion that is one radial end portion of the stator core.

### Fifth Embodiment

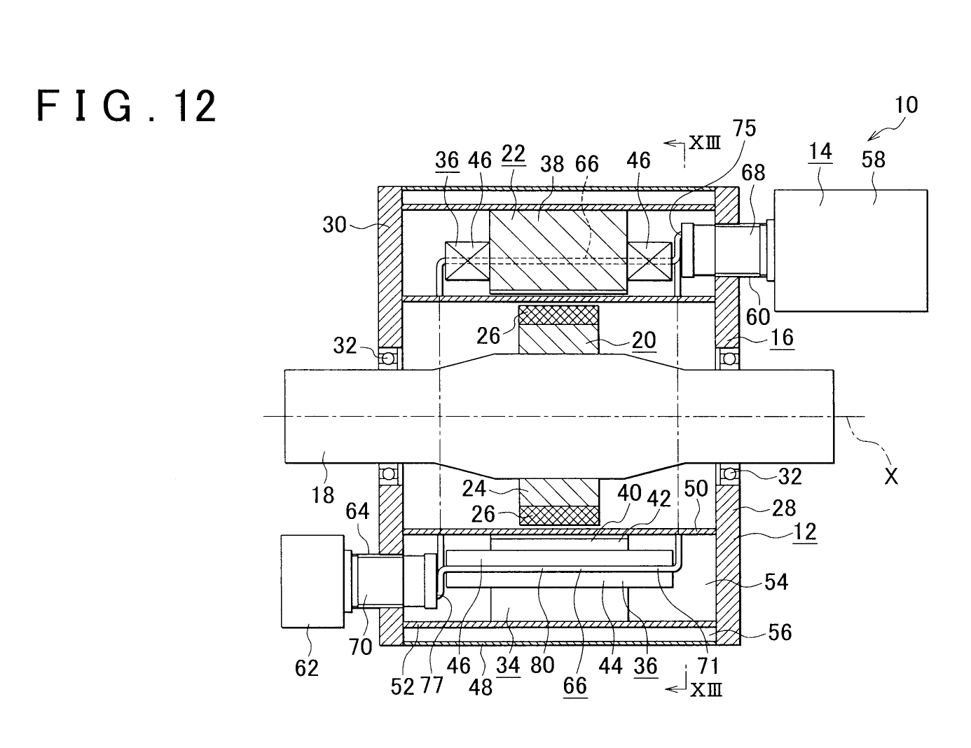

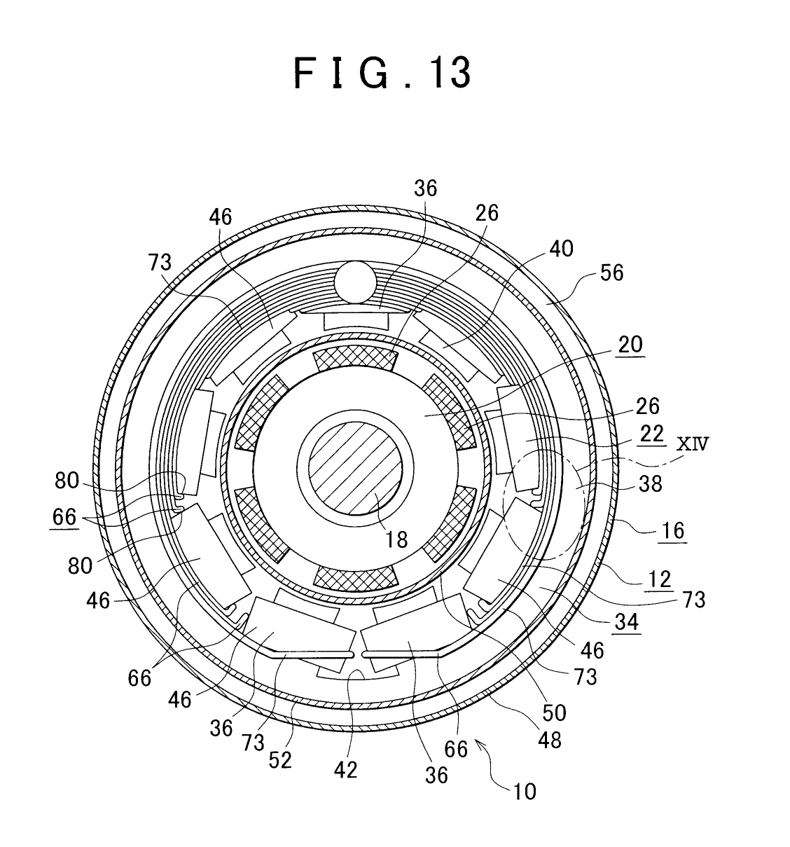

FIG. 12 and FIG. 13 show a superconducting electric motor according to a fifth embodiment of the invention. As shown in FIG. 12 and FIG. 13, the superconducting electric motor 10 includes a motor body 12 and a refrigerator 14. The refrigerator 14 is used to cool the motor body 12. The motor body 12 includes a motor case 16, a rotary shaft 18 and a rotor 20. The rotary shaft 18 is rotatably supported by the motor case 16. The rotor 20 is fixed to the outer side of the rotary shaft 18 inside the motor case 16 and is rotatably arranged. In addition, the motor body 12 includes a substantially cylindrical stator 22. The stator 22 is fixed to the inner peripheral surface of the motor case 16, and is arranged on the radially outer side of the rotor 20 so as to face the rotor 20. In addition, the refrigerator 14 is fixed to the motor case 16. Note that, in the following description, unless otherwise specified, a direction along the rotation central axis X of the rotary shaft 18 is termed axial direction, a radial direction perpendicular to the rotation central axis X is termed radial direction, and a direction along a circle about the rotation central axis X is termed circumferential direction.

The rotor 20 includes a cylindrical rotor core 24 and a plurality of permanent magnets 26. The rotor core 24 is, for example, formed so that flat rolled magnetic steel sheets are laminated and integrated by crimping, welding, or the like. The permanent magnets 26 are provided at equal intervals on the outer peripheral surface of the rotor core 24. That is, the plurality of (six in the example shown in FIG. 13) permanent magnets 26 are fixed to the outer peripheral surface of the rotor core 24 at equal intervals in the circumferential direction so that the permanent magnets 26 are exposed. The permanent magnets 26 are magnetized in the radial direction, and the magnetized directions of the permanent magnets 26 are alternately varied in the circumferential direction. Therefore, north poles and south poles are alternately arranged on the outer peripheral surface of the rotor 20. However, the permanent magnets 26 of the rotor 20 may not be exposed on the outer peripheral surface, and may be embedded inside near the outer peripheral surface. The thus configured rotor 20 is fixed to the outer peripheral surface of the rotary shaft 18 made of round bar steel material, or the like.

The rotary shaft 18 is rotatably supported by bearings 32 at its both end portions. The bearings 32 are respectively fixed to disc-shaped end plates 28 and 30. The end plates 28 and 30 respectively constitute both end portions of the motor case 16. By so doing, as a revolving magnetic field is generated in the stator 22, the rotor 20 receives the influence of the revolving magnetic field to rotate.

The stator 22 includes a stator core 34 and coils 36. The stator core 34 has a substantially cylindrical shape and serves as a stator iron core. The coils 36 serve as superconducting coils. That is, the stator core 34 has an annular back yoke 38 and a plurality of (nine in the example shown in FIG. 13) teeth 40. The teeth 40 are provided at multiple positions of an inner peripheral end portion at equal intervals in the circumferential direction so as to protrude in the radial direction. The inner peripheral end portion is one radial end portion of the back yoke 38. In addition, the stator core 34 has a plurality of (nine in the example of the drawing) slots 42 that are provided at multiple positions at equal intervals in the circumferential direction. Each of the slots 42 is provided between two of the teeth 40, adjacent in the circumferential direction, at the inner peripheral portion of the back yoke 38. The stator core 34 may be, for example, formed in such a manner that a plurality of substantially annular flat rolled magnetic steel sheets are laminated in the axial direction and are integrally assembled by crimping, adhesion, welding, or the like. Instead, the stator core may be formed in such a manner that a plurality of split cores each having one tooth are arranged continuously in an annular shape and fastened by a cylindrical fastening member from the outer side. The split cores may be formed of dust core.

The plurality of coils 36 formed of a superconducting wire material are respectively wound around the plurality of teeth 40 of the stator core 34 by concentrated winding. Note that the plurality of coils 36 may be respectively wound around the teeth 40 by distributed winding. In addition, the superconducting wire material may have a circular cross-sectional shape or a rectangular cross-sectional shape. For example, the coils 36 may be formed in such a manner that a superconducting wire material that is a flat wire having a rectangular cross-sectional shape is wound in a flatwise manner. For example, the coils 36 may be formed in such a manner that a superconducting wire material is wound around each of the teeth 40 by solenoidal winding or pancake winding. In addition, the superconducting wire material may be suitably, for example, an yttrium series superconducting material or a bismuth series superconducting material. However, the superconducting material that constitutes the superconducting wire material is not limited to these materials; it may be another known superconducting material or a superconducting material that will be developed in the future and that exhibits a superconducting property at a higher temperature.

The superconducting wire material that constitutes each coil 36 may be covered with insulating coating. By so doing, when the superconducting wire material is wound so as to be in closely contact with one another to form each coil 36, electrical insulation is ensured among the turns of each coil 36. Instead, when the superconducting wire material is not covered with insulating coating, the superconducting wire material may be wound into a coil shape while placing insulating paper, insulating film, or the like, in between at the time of forming each coil 36 to thereby ensure electrical insulation among the turns of each coil 36.

Each coil 36 has in-slot portions 44 and two coil end portions 46. The in-slot portions 44 are respectively located in corresponding two of the plurality of slots 42 provided at multiple positions of the stator core 34. The two coil end portions 46 respectively protrude axially outward from both axial end surfaces of the stator core 34. Three of the coils 36, which place two coils 36 in between, are connected in series with one another to constitute any one of U, V and W phase coils. One ends of the phase coils are connected to one another at a neutral point (not shown), and the other ends of the phase coils are respectively connected to phase current introducing terminals (not shown).

In addition, the motor case 16 accommodates the rotor 20 and the stator 22. The motor case 16 has a cylindrical outer peripheral cylindrical portion 48 and the pair of end plates 28 and 30. The outer peripheral edge portions of the pair of end plates 28 and 30 are respectively airtightly connected to both axial end portions of the outer peripheral cylindrical portion 48. The outer peripheral cylindrical portion 48 and the end plates 28 and 30 are, for example, formed of a non-magnetic material, such as stainless steel. Note that the outer peripheral cylindrical portion 48 and the one-side end plate 28 (or 30) may be formed of an integral member.

An inner cylindrical member 50 and an intermediate cylindrical member 52 are provided inside the outer peripheral cylindrical portion 48 concentrically with the rotor 20. The inner cylindrical member 50 and the intermediate cylindrical member 52 each have a cylindrical shape. Both axial end portions of each of the inner cylindrical member 50 and intermediate cylindrical member 52 are respectively airtightly coupled to the inner surfaces of the end plates 28 and 30. The inner cylindrical member 50 is desirably formed of a non-metal material (for example, FRP, or the like) that does not interfere with passage of a magnetic field and that is electrically not conductive. More desirably, the inner cylindrical member 50 is formed of a material having a low thermal conductivity. Note that the inner cylindrical member 50 just needs to have the function of passing a magnetic field and the function of being able to retain vacuum at a space sealing portion, including the inner cylindrical member 50, as basic functions, and is not limited to the one using an electrically non-conductive material. For example, a non-magnetic material having a low electrical conductivity (for example, stainless steel, or the like) may also be used as the material that constitutes the inner cylindrical member 50. On the other hand, the intermediate cylindrical member 52 is desirably formed of a material having a low thermal conductivity (for example, FRP, or the like), and is more desirably formed of a non-magnetic material having a low thermal conductivity.

The inner cylindrical member 50 has an inside diameter that is slightly larger than the diameter of the outermost circumcircle of the rotor 20. A gap is formed between the inner cylindrical member 50 and the outer peripheral surface of the rotor 20. In addition, a first vacuum chamber 54 is provided between the inner cylindrical member 50 and the intermediate cylindrical member 52. The first vacuum chamber 54 is a cylindrical space. The stator 22 that includes the coils 36 are accommodated in the first vacuum chamber 54. The outer peripheral surface of the stator core 34 that constitutes the stator 22 is fixed to the inner peripheral surface of the intermediate cylindrical member 52.

The first vacuum chamber 54 is maintained in a vacuum condition in such a manner that, after the superconducting electric motor 10, including the refrigerator 14 described in detail later, is assembled, air is evacuated through an air vent hole (not shown) formed in at least any one of members, such as the end plates 28 and 30 and the outer peripheral cylindrical portion 48, that adjoin an external space and one or both of the first vacuum chamber 54 and a second vacuum chamber 56. In this way, the first vacuum chamber 54 is defined by the inner cylindrical member 50, which is not in contact with the coils 36 and the stator 22, and the intermediate cylindrical member 52 having a low thermal conductivity, and the inside of the first vacuum chamber 54 is evacuated. By so doing, it is possible to enhance heat insulation to the stator 22, including the coils 36, accommodated in the first vacuum chamber 54.

Furthermore, the second vacuum chamber 56 is formed between the intermediate cylindrical member 52 and the motor case 16. The second vacuum chamber 56 is formed of a cylindrical space. The second vacuum chamber 56, as well as the first vacuum chamber 54, is in a vacuum condition. A hole that provides fluid communication between the first vacuum chamber 54 and the second vacuum chamber 56 is desirably provided for the intermediate cylindrical member 52. By so doing, the stator 22, which includes the coils 36 and which is accommodated in the first vacuum chamber 54, is isolated from the outside of the motor additionally by the second vacuum chamber 56. Thus, it is possible to further enhance heat insulation effect to the stator 22 including the coils 36.

In addition, the refrigerator 14 is fixed to the motor body 12 that constitutes the superconducting electric motor 10. Note that the basic configuration of the refrigerator 14 has been already described with reference to FIG. 3 and FIG. 4, so the description thereof is omitted.

In the present embodiment, the refrigerator 14 having such a basic configuration is fixed to the motor body 12 (FIG. 12). That is, as shown in FIG. 12, in the superconducting electric motor 10, a cylindrical first bracket 60 adjacent to the pressure vibration source 58 that constitutes the refrigerator 14 is fixed to the end plate 28 located at one axial end, and a cylindrical second bracket 64 adjacent to the phase controller 62 that constitutes the refrigerator 14 is fixed to the end plate 30 located at the other axial end. In addition, the pressure vibration source 58 and the second piston accommodating portion 70 are provided at opposite sides in the diametrical direction with respect to the rotation central axis X of the rotor 20. In addition, one end portion of the cool storage device 68 and one end portion of the second piston accommodating portion 70 respectively protrude into the first vacuum chamber 54 via the inside of the first bracket 60 and the inside of the second bracket 64.

In addition, as shown in FIG. 13, the longitudinal center portions of the plurality of narrow tubes 66, which serve as the low-temperature-side heat exchanging portion, are arranged two by two in each of the slots 42 that constitute the stator core 34. That is, each narrow tube 66 has a linear straight portion 80 that extends parallel to the rotation axis X of the rotary shaft 18. At least part of linear straight portion 80 is arranged in a corresponding one of the slots 42. In the example of the drawing, the straight portions 80 of the two narrow tubes 66 are arranged in each of the slots 42. At least part of each straight portion 80 is arranged in a corresponding one of the slots 42 between two of the coils 36, adjacent in the circumferential direction of the stator 22. In the example of the drawing, the entire portion of each straight portion 80, arranged in the corresponding slot 42, is arranged between two of the coils 36, adjacent in the circumferential direction of the stator 22. Therefore, the plurality of narrow tubes 66 each have an axial straight portion 80 that is provided in the stator core 34 and that serves as an extended portion extending in the axial direction of the stator 22. In addition, part of each of the plurality of straight portions 80, arranged in a corresponding one of the plurality of slots 42, constitutes a straight in-slot portion 71 parallel to the axial direction.

In addition, the two straight portions 80 arranged in each slot 42 are arranged apart from each other in the circumferential direction. The circumferential one-side straight portion 80 is in contact with the outer peripheral portion of the circumferential one-side coil 36 in each slot 42, and the circumferential other-side straight portion 80 is in contact with the outer peripheral portion of the circumferential other-side coil 36 in each slot 42. Each of the straight portions 80 is not in contact with the back yoke 38 of the stator core 34. That is, each narrow tube 66 is only in contact with one coil 36 in a corresponding one of the slots 42. Therefore, cold is transferred from each narrow tube 66 to a corresponding one of the coils 36 via the contact portion with the narrow tube 66. In this way, each of the plurality of narrow tubes 66 is configured so that the in-slot portion 71 that is the center portion of the straight portion 80 is arranged in a corresponding one of the slots 42. In addition, as shown in FIG. 13, portions of each narrow tube 66, respectively protruding outward from between two of the coils 36, adjacent in the circumferential direction, each have a circumferential portion 73 that is coupled to the end portion of the straight portion 80 and that is shaped along substantially the circumferential direction of the stator core 34. In addition, one end of each circumferential portion 73 is connected to the cool storage device 68 (FIG. 12) or the second piston accommodating portion 70 (FIG. 12). In addition, as shown in FIG. 13, at least part of each circumferential portion 73 faces the axial end surface portion of the coil end portion 46 that constitutes at least one of the plurality of coils 36 and is brought into contact with the coil end portion 46. In addition, the total length of the circumferential portions 73 that are provided for each narrow tube 66 and that are arranged on both axial end portions of the stator 22 is substantially equal among the narrow tubes 66. Therefore, the radius of curvature of the circular arc of each circumferential portion 73 of each narrow tube 66 about the center of the rotary shaft 18 may be substantially equal among the narrow tubes 66 and between the circumferential portions 73 of each narrow tube 66.

Connecting portions 75 and 77, each of which connects one end of the corresponding circumferential portion 73 to the cool storage device 68 or the second piston accommodating portion 70, respectively serve as a one-side connecting portion and an other-side connecting portion that are refrigerant supply/drain connecting portions at both ends of each of the plurality of narrow tubes 66. These connecting portions 75 and 77 are respectively provided on both axial sides of the stator 22 at opposite sides in the diametrical direction with respect to the rotation central axis X of the rotor 20.

With the above configuration, the narrow tubes 66 of which the number is twice the number of the slots 42 of the stator core 34 are provided. That is, the low-temperature-side heat exchanging portion is formed of the narrow tubes 66 of at least the same number as the number of the slots 42 of the stator core 34. In addition, each of the plurality of narrow tubes 66 is arranged parallel to the rotary shaft 18 in a corresponding one of the slots 42, and is in contact with a corresponding one of the coils 36 so as to cool the coil 36. In addition, the cross-sectional area of each of the plurality of narrow tubes 66 is equal or substantially equal to one another.

With the above configuration, a high-temperature-side heat exchanging portion is formed of an end portion of the second piston accommodating portion 70, arranged outside of the motor case 16. The above refrigerator 14 includes the pressure vibration source 58, the high-temperature-side heat exchanging portion, the cool storage device 68, the low-temperature-side heat exchanging portion and the second piston 78 (FIG. 3).

With the above superconducting electric motor 10, the plurality of narrow tubes 66 that constitute the refrigerator 14 and that flow low-temperature refrigerant gas inside each have the axial straight portion 80 that serves as an extended portion provided in the stator core 34 and extending in the axial direction of the stator 22, so the plurality of coils 36 may be efficiently cooled to a desired cryogenic temperature. In addition, both connecting portions 75 and 77 that serve as the refrigerant supply/drain connecting portions at both ends of each of the plurality of narrow tubes 66 are provided on both axial sides of the stator 22 at opposites sides in the diametrical direction with respect to the rotation central axis X of the rotor 20. Therefore, the difference in length may be reduced or eliminated, for example, so that the plurality of narrow tubes 66 have a substantially uniform length. For example, different from the present embodiment, in the case of the comparative embodiment that the cool storage device 68 and the second piston accommodating portion 70 are arranged along the common straight line parallel to the rotation axis X, the length of each of a portion of the narrow tubes, having a straight portion that penetrates through the stator core 34 at a portion that coincides in the circumferential direction with the cool storage device 68 or the second piston accommodating portion 70, is small, and the length of each of the other narrow tubes, having a straight portion that axially penetrates through the stator core 34 at a portion largely apart in the circumferential direction from the cool storage device 68 and the second piston accommodating portion 70, is large. With the configuration of this comparative embodiment, the lengths of the plurality of narrow tubes are significantly different from one another, so there is room for improvement in terms of eliminating or reducing a temperature difference, for example, in such a manner that the degrees of cooling of the plurality of superconducting coils cooled by the plurality of narrow tubes are uniformized to cool the plurality of superconducting coils to a substantially uniform temperature.

In contrast to this, according to the present embodiment, such a point to be improved may be improved, the multiple positions of the stator 22 in the circumferential direction may be cooled by the plurality of narrow tubes 66 with substantially the same cooling ability, and the plurality of coils 36 may be cooled while eliminating or reducing the temperature difference, for example, the plurality of coils 36 may be cooled uniformly. As a result, the plurality of coils 36 arranged at multiple positions of the stator 22 in the circumferential direction may be efficiently cooled to a desired cryogenic temperature while reducing or eliminating the temperature difference among one another. Furthermore, the difference in length among the plurality of narrow tubes 66 may be reduced or eliminated by uniformizing the lengths of the plurality of narrow tubes 66, so refrigeration performance may be improved. That is, the performance of the refrigerator 14 requires that pressure variations in the low-temperature portion heat exchanger and the piston arrangement spaces and positional variations in refrigerant gas serving as working gas are maintained at appropriate phase angles. If it is assumed that a variation in phase angle in one narrow tube, that is, a variation in phase angle that varies in one narrow tube, has been optimized, the variation in phase angle for a narrow tube having another length deviates from an optimal value. Therefore, all the narrow tubes have substantially the same length to thereby make it possible to obtain a phase angle close to an optimal value in all the narrow tubes and to improve refrigeration performance. In the present embodiment, the plurality of narrow tubes 66 may have a substantially equal length or may be brought close to the same length, so refrigeration performance may be improved.

In addition, at least part of each narrow tube 66 is arranged in a corresponding one of the slots 42 between two of the coils 36, adjacent in the circumferential direction of the stator 22. Therefore, the narrow tubes 66 may be brought into direct contact with the corresponding coils 36 in the slots 42, so the coils 36 may be efficiently cooled to a desired cryogenic temperature. In addition, the coils 36 are cooled by the narrow tubes 66 without intervening the stator core 34 having a large thermal capacity, so the coils 36 are early cooled at the time of starting the superconducting electric motor 10 while suppressing power consumption to thereby make it possible to reduce a period of time that elapses until the coils 36 are placed in a superconducting condition. As a result, the coils 36 may be efficiently cooled to a desired cryogenic temperature, and the coils 36 may be early placed in a superconducting condition at the time of starting the superconducting electric motor 10.

In addition, each narrow tube 66 has the straight portion 80 that is an extended portion extending parallel to the axial direction of the stator 22 in a corresponding one of the slots 42, and the in-slot portion 71 of each straight portion 80 is only in contact with the coil 36 in a corresponding one of the slots 42. In this way, the straight portions 80 do not contact with the stator core 34 via the back yoke 38, or the like, so cold may be further efficiently transferred from the narrow tubes 66 to the coils 36 to further early cool the coils 36 at the time of starting the superconducting electric motor 10. In this case, more desirably, the insulator (not shown) that is provided around each tooth 40 and that is arranged between the tooth 42 and the coil 36 is formed of a material having a poor thermal conductivity, such as glass fiber reinforced resin (GFRP), or is formed in a shape that decreases thermal conductivity from the tooth 40 to the coil 36, such as an annular comb-tooth shape or a shape having holes at multiple positions of an annular portion. In this case, the coils 36 may be further effectively early cooled. In addition, for example, in the coils 36, different from the case of a configuration that only the coil end portions 46 are cooled, the in-slot portions 44 of the coils 36 may be efficiently cooled, so the whole of the coils 36, which are superconducting coils, are easily cooled further uniformly. That is, the coils 36 may be further effectively cooled while reducing a biased temperature distribution among the whole of the coils 36.

Note that the straight portions 80 of two of the narrow tubes 66 are arranged in each of the slots 42 in the above description; instead, it is also applicable that only the straight portion 80 of one narrow tube 66 is arranged in each of the slots 42 and the one straight portion 80 is only in contact with any one of two of the coils 36, adjacent in the circumferential direction (for example, only one-side coil 36 in the circumferential direction) in each of the slots 42. In this case as well, one narrow tube 66 is in contact with each of the coils 36, so the coils 36 may be efficiently cooled. In addition, each straight portion 80 is only in contact with the coil 36 in a corresponding one of the slots 42 in the above description; instead, each straight portion 80 may be in contact with both the coil 36 and the stator core 34 in a corresponding one of the slots 42. In this case, not only the coils 36 but also the stator core 34 having a large thermal capacity is directly cooled by the narrow tubes 66, so the stator core 34 may function as a buffer when the coils 36 are cooled by the narrow tubes 66. Therefore, even during a high load of the superconducting electric motor or in a transitional motor operating state, it is possible to effectively prevent a situation that cooling using the narrow tubes 66 cannot follow an increase in the temperature of the coils 36 even during a high load or in a transitional motor operating state. By so doing, it is possible to stably continue cooling the coils 36. As a result, a stable superconducting condition may be effectively generated.

Conversely, each straight portion 80 may be configured so as not to be in contact with the coil 36 in a corresponding one of the slots 42 but only in contact with the stator core 34 at the bottom, or the like, of a corresponding one of the slots 42. In this case, the coils 36 may be indirectly cooled by the narrow tubes 66 via the stator core 34 having a large thermal capacity. In this case as well, even during a high load of the superconducting electric motor or in a transitional motor operating state, it is possible to effectively prevent a situation that cooling using the narrow tubes 66 cannot follow an increase in the temperature of the coils 36 even during a high load or in a transitional motor operating state. By so doing, it is possible to stably continue cooling the coils 36. Note that, in this case, each insulator that is provided between the tooth 40 and the coil 36 and that has an electrical insulation property is desirably made of a material having a high thermal conductivity, such as resin that contains a filler, such as silica and alumina.

### Sixth Embodiment

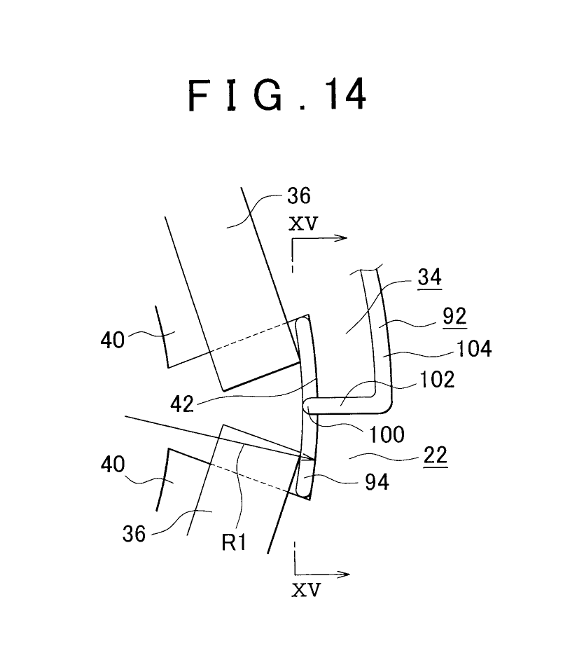

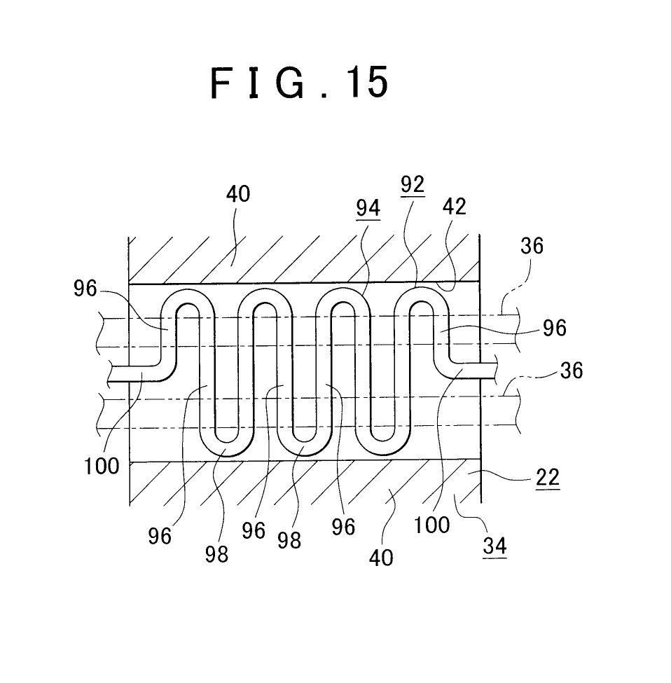

FIG. 14 is a view that shows a superconducting electric motor according to a sixth embodiment of the invention and that corresponds to enlarged portion XIV in FIG. 13. FIG. 15 is a cross-sectional view that is taken along the line XV-XV in FIG. 14.

The present embodiment differs from the fifth embodiment in that no straight portion that axially extends over the entire axial length of the slot 42 is provided at the center portion of each of the plurality of narrow tubes 66, arranged in a corresponding one of the slots 42. Instead, in the present embodiment, each of the plurality of narrow tubes 92 has a meandering portion 94 having a meander shape at its center portion that is the in-slot portion arranged in a corresponding one of the slots 42. The meandering portion 94 is an extended portion extending in the axial direction of the stator 22. As shown in FIG. 15, each meandering portion 94 flows refrigerant gas inside, and has a plurality of circumferential portions 96 and substantially U-shaped coupling portions 98. The plurality of circumferential portions 96 extend in the circumferential direction (vertical direction in FIG. 15) of the stator 22. The coupling portions 98 each couple the end portions of the adjacent circumferential portions 96. Each meandering portion 126 extends in the axial direction (horizontal direction in FIG. 15) of the stator 22 as a whole. In addition, in each meandering portion 94, straight portions 100 that extend in the axial direction of the stator 22 are respectively coupled to the end portions of the circumferential portions 96 located at both axial ends of the slot 42.

In addition, as shown in FIG. 14, an outer radial portion 102 that extends radially outward (rightward in FIG. 14) is coupled to the end portion of each straight portion 100, arranged on the axially outer side with respect to the axial end surface of the stator core 34, and the radially outer end of the outer radial portion 102 is coupled to an outer circumferential portion 104 that extends in the circumferential direction. One end of the outer circumferential portion 104 is connected to the cool storage device 68 (FIG. 12) or the second piston accommodating portion 70 (FIG. 12).

As shown in FIG. 14, in the meandering portion 94 arranged in each slot 42, the outer peripheral edge (right end edge in FIG. 14) in the radial direction of the stator 22 is in contact with the bottom of the slot 42. In addition, as shown in FIG. 14 and FIG. 15, both end portions of each circumferential portion 96 of each meandering portion 94 in the circumferential direction of the stator 22 are respectively in contact with the outer end portions of the circumferentially adjacent two coils 36 in the radial direction of the stator 22. That is, each narrow tube 66 is interposed between the stator core 34 and the end portions of the two coils 36 and is in thermal contact with both the stator core 34 and the end portions of the two coils 36. In the example of FIG. 14, both end portions of each circumferential portion 96 of each meandering portion 94 are respectively in contact with the coils 36. Note that it is also applicable that the end portions of the coils 36 are in contact with the coupling portions 98 of each meandering portion 94. In this case, the contact area between the coils 36 and the meandering portion 94 is easily increased. Note that the “thermal contact” in this specification includes not only direct contact between members that mutually transfer heat but also contact via a member having a thermal conductivity.

In addition, as shown in FIG. 14, each meandering portion 94 is curved in a substantially circular arc shape so that each circumferential portion 96 is aligned along the bottom of the slot 42, having a circular arc cross-sectional shape, when viewed in the axial direction of the stator 22 and is pressed against the bottom. For example, in a free state of each meandering portion 94, that is, a state where each meandering portion 94 is removed from the slot 42, the radius of curvature of the circular arc of the circular arc-shaped portion, which includes the circumferential portion 96 and which faces the bottom of the slot 42, may be larger than the radius of curvature R1 of the circular arc shape of the bottom of the slot 42. That is, in each meandering portion 94, the outer peripheral edge of the meandering portion 94, which is directed radially outward of the stator 22, is curved in a circular arc shape, and a part or whole of the outer end circle of the meandering portion 94 is brought into contact with the bottom of the slot 42 along the circumferential direction. Furthermore, the diameter of the outer peripheral edge in the free state of each meandering portion 94 is larger than the diameter of the circular arc cross-sectional shape of the bottom of the slot 42. With the above configuration, the contact pressure between the bottom of the slot 42 and the meandering portion 94 increases, so heat transport, that is, the efficiency of transfer of cold, is improved. In addition, the shape and length of the meandering portion 94 of each narrow tube 92 is equal among the narrow tubes 92. That is, each narrow tube 92 has the same meandering portion 94 among the narrow tubes 92. Therefore, the length of part of each narrow tube 94, arranged in a corresponding one of the slots 42, is substantially uniform.

In the case of the above present embodiment as well, the coils 36 formed of a superconducting wire material are efficiently cooled to a desired cryogenic temperature, a stable superconducting condition may be effectively generated even during a high load or in a transitional motor operating state.

In addition, each narrow tube 92 has the meandering portion 94 that serves as an extended portion extending in the axial direction of the stator 22 in a corresponding one of the slots 42, and each meandering portion 94 is in contact with both the bottom of the slot 42 of the stator core 34 and the coils 36 so as to be in thermal contact with both the stator core 34 and the coils 36. Therefore, different from the configuration that only the coil end portions are cooled, the entire portion of each coil 36 is easily cooled further uniformly. That is, the coils 36 may be further effectively cooled while reducing a biased temperature distribution among the whole of the coils 36. The other configuration and function are the same as those of the fifth embodiment.

Note that, in the present embodiment, it is applicable that each meandering portion 94 is not brought into contact with the coils 36 in a corresponding one of the slots 42 but is only brought into contact with the stator core 34 at the bottom, or the like, of a corresponding one of the slots 42. In this case, the coils 36 are brought into thermal contact with the teeth 40 of the stator core 34 to thereby make it possible to cool the coils 36 with the narrow tubes 92. For example, by providing a gap between each meandering portion 94 and corresponding two of the coils 36, each narrow tube 92 may be brought into thermal contact with the back yoke 38 without bringing each meandering portion 94 into contact with the corresponding two of the coils 36. In this case as well, the stator core 34 having a large thermal capacity functions as a buffer at the time of cooling the coils 36 to make it possible to effectively generate a stable superconducting condition even during a high load or in a transitional motor operating state. Note that, in the example of the drawing, both ends of each meandering portion 94 in the circumferential direction of the stator 22 are respectively spaced apart from the side surfaces of corresponding two of the teeth 40; however, both ends of each meandering portion 94 in the circumferential direction of the stator 22 may be respectively brought into thermal contact with the side surfaces of corresponding two of the teeth 40.

### Seventh Embodiment

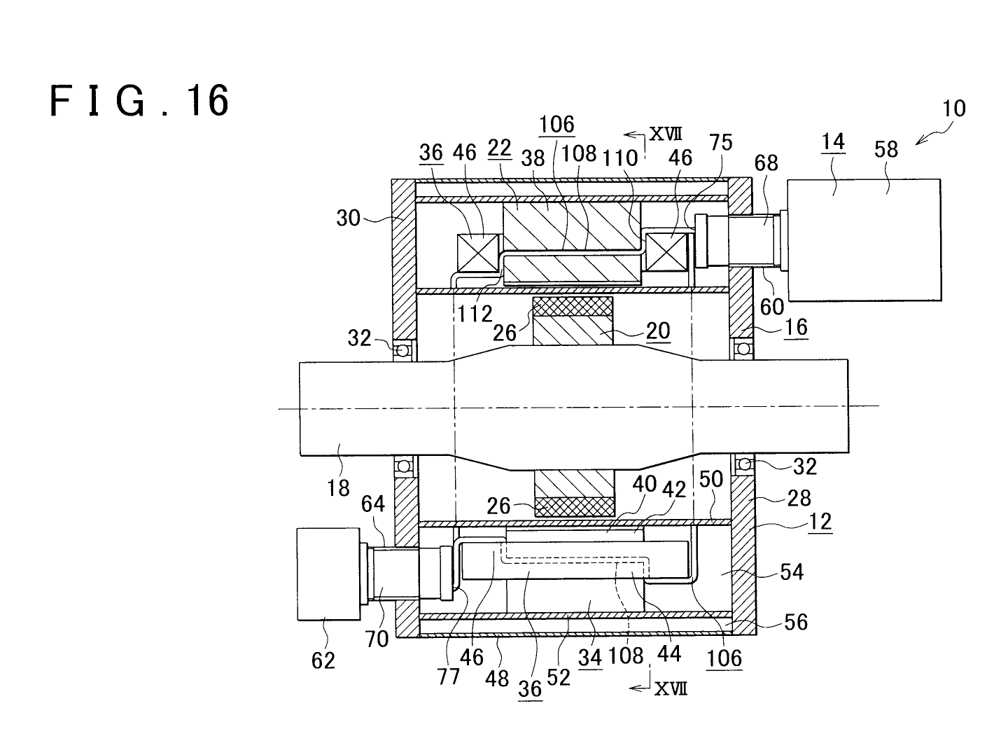

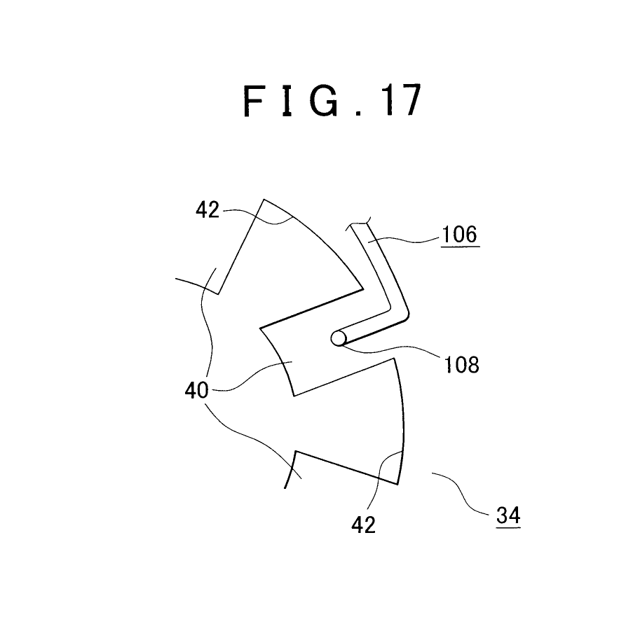

FIG. 16 is an axially cross-sectional view that shows a superconducting electric motor according to a seventh embodiment of the invention. FIG. 17 is a view that corresponds to an enlarged cross-sectional view of a portion of the superconducting electric motor in the circumferential direction, taken along the line XVII-XVII in FIG. 16.

In the case of the superconducting electric motor 10 according to the present embodiment, the plurality of narrow tubes 106 respectively have straight core penetrating portions 108 that axially penetrate through at positions spaced apart from one another in the circumferential direction of the stator core 34. As shown in FIG. 17, each of the plurality of core penetrating portions 108 axially penetrates through the circumferential center portion of a corresponding one of the plurality of teeth 40 that constitute the stator core 34. That is, the narrow tubes 106 of which the number is equal to the number of the teeth 40 are provided, and each of the narrow tubes 106 has the core penetrating portion 108 that penetrates through a corresponding one of the teeth 40. As shown in FIG. 16, part of each narrow tube 106 between one end (right end in FIG. 16) of the core penetrating portion 108 and the cool storage device 68 has an outer radial portion 110 that is coupled to one end of the core penetrating portion 108 and that extends radially outward on the axially outer side of the axial end surface of the stator core 34. In addition, each outer radial portion 110 is connected to the cool storage device 68 via another part, or the like, of each narrow tube 106, which passes through the radially outer side of the coil end portion 46.

In addition, part of each narrow tube 106 between the other end (left end in FIG. 16) of the core penetrating portion 108 and the second piston accommodating portion 70 has a second outer radial portion 112 that is coupled to the other end of the core penetrating portion 108 and that extends radially inward on the axially outer side of the axial end surface of the stator core 34, and each of the second outer radial portions 112 is connected to the second piston accommodating portion 70 via another part, or the like, of each narrow tube 106, which passes through the radially inner side of the coil end portion 46.

With the above configuration, each of the plurality of narrow tubes 106 has the core penetrating portion 108 that penetrates through the stator core 34, so the coils 36 respectively wound around the teeth 40 may be cooled by the plurality of narrow tubes 106 via the teeth 40. In this case, the plurality of narrow tubes 106 are not brought into direct contact with the coils 36; however, different from the configuration that the narrow tubes are brought into contact with the outer peripheral surface side of the stator core 34 to cool the coils 36, the coils 36 may be cooled by bringing the narrow tubes 106 close to the coils 36, so cooling performance is improved. In addition, the stator core 34 having a large thermal capacity functions as a buffer at the time of cooling the coils 36 to make it possible to effectively generate a stable superconducting condition even during a high load or in a transitional motor operating state. The other configuration and function are the same as those of the fifth embodiment shown in FIG. 12 and FIG. 13.

Note that, in the present embodiment, between both end portions of each narrow tube 106, protruding from both axial ends of the stator core 34, one end adjacent to the cool storage device 68 passes through the radially outer side of the coil end portion 46, and the other end adjacent to the second piston accommodating portion 70 passes through the radially inner side of the coil end portion 46. Instead, it is also applicable that, between both end portions of each narrow tube, protruding from both axial ends of the stator core 34, one end adjacent to the cool storage device 68 passes through the radially inner side of the coil end portion 46, and the other end adjacent to the second piston accommodating portion 70 passes through the radially outer side of the coil end portion 46. In addition, it is applicable that both end portions of each narrow tube, protruding from both axial ends of the stator core 34, pass through one of the radially inner side or radially outer side of the corresponding coil end portions 46.

Note that, in the above embodiments, the aspect of the invention is applied to the inner rotor structure in which the stator is arranged on the radially outer side of the rotor so as to face the rotor. However, the aspect of the invention is not limited to this configuration. The aspect of the invention may be applied to an outer rotor structure in which the stator is arranged on the radially inner side of the rotor so as to face the rotor. In this case, the superconducting coils are wound at an outer peripheral end portion that is one radial end portion of the stator core.

What is claimed is:

1. A superconducting electric motor comprising:
a rotor that is rotatably arranged;
a stator that is arranged in a radial direction of the rotor so as to face the rotor; and
a refrigerator that has at least one narrow tube that flows low-temperature refrigerant inside, wherein
the stator has a stator core and a plurality of superconducting coils that are wound at a radial end portion of the stator core and that are formed of a superconducting wire material, and
the at least one narrow tube has a core penetrating portion that is provided so as to penetrate through the stator core.

2. The superconducting electric motor according to claim 1, wherein
the stator core has an annular back yoke, a plurality of teeth that radially protrude from a radial end portion of the back yoke, and slots, each of which is provided between two of the teeth that are adjacent in a circumferential direction of the stator,
the superconducting coils are respectively wound around the teeth, and
the core penetrating portion is provided so as to penetrate through the back yoke.

3. The superconducting electric motor according to claim 1, wherein
the stator core has an annular back yoke, a plurality of teeth that radially protrude from a radial end portion of the back yoke, and slots, each of which is provided between two of the teeth that are adjacent in a circumferential direction of the stator,
the superconducting coils are respectively wound around the teeth, and
the core penetrating portion is provided so as to penetrate through one of the teeth.

4. The superconducting electric motor according to claim 1, wherein
the stator core has an annular back yoke, a plurality of teeth that radially protrude from a radial end portion of the back yoke, and slots, each of which is provided between two of the teeth that are adjacent in a circumferential direction of the stator,
the superconducting coils are respectively wound around the teeth, and
the refrigerator has a first narrow tube and a second narrow tube, each of which flows low-temperature refrigerant inside,
the first narrow tube has a first core penetrating portion that is provided so as to penetrate through the back yoke, and
the second narrow tube has a second core penetrating portion that is provided so as to penetrate through one of the teeth.

5. A superconducting electric motor comprising:
a rotor that is rotatably arranged;
a stator that is arranged in a radial direction of the rotor so as to face the rotor; and
a refrigerator that has a plurality of narrow tubes that flow low-temperature refrigerant inside, wherein
the stator has a stator core and a plurality of superconducting coils that are respectively wound around multiple radial end portions of the stator core arranged in a circumferential direction of the stator core and that are formed of a superconducting wire material,
at least part of each of the plurality of narrow tubes is provided in the stator core, and
a one-side connecting portion and an other-side connecting portion that are refrigerant supply/drain connecting portions at both ends of each of the plurality of narrow tubes are respectively provided on both axial sides of the stator at opposite sides in a diametrical direction with respect to a rotation central axis of the rotor.

6. The superconducting electric motor according to claim 5, wherein
the stator core has an annular back yoke, a plurality of teeth that radially protrude from a radial end portion of the back yoke, and slots, each of which is provided between two of the teeth that are adjacent in a circumferential direction of the stator,
the plurality of superconducting coils are respectively wound around the plurality of teeth, and
the plurality of narrow tubes each have an in-slot portion that is arranged in a corresponding one of the plurality of slots.

7. The superconducting electric motor according to claim 6, wherein
each of the plurality of in-slot portions is only in contact with one or two of the superconducting coils in a corresponding one of the slots.

8. The superconducting electric motor according to claim 6, wherein
each of the plurality of in-slot portions is only in contact with the stator core in a corresponding one of the slots.

9. The superconducting electric motor according to claim 6, wherein
each of the plurality of in-slot portions is in contact with the stator core and one or two of the superconducting coils in a corresponding one of the slots.

10. The superconducting electric motor according to claim 6, wherein
the refrigerator has the plurality of narrow tubes of which the number is at least equal to the number of the slots.

11. The superconducting electric motor according to claim 6, wherein
the in-slot portions are arranged in each of the slots in equal numbers.

12. The superconducting electric motor according to claim 6, wherein
the plurality of narrow tubes of which the number is equal to the number of the teeth are provided, and
each of the plurality of narrow tubes has a core penetrating portion that penetrates through a corresponding one of the teeth.

13. The superconducting electric motor according to claim 5, wherein
the plurality of narrow tubes respectively have core penetrating portions that axially penetrate through at positions spaced apart from each other in a circumferential direction of the stator core.
